(19) United States
(12) Patent Application Publication
(10) Pub. No.: US 2018/0003993 A1
(43) Pub. Date: Jan. 4, 2018

(54) DETECTOR FOR AN OPTICAL DETECTION OF AT LEAST ONE OBJECT

(71) Applicant: BASF SE, Ludwigshafen (DE)

(72) Inventors: Robert SEND, Karlsruhe (DE); Ingmar BRUDER, Neuleiningen (DE); Sebastian VALOUCH, Lampertheim (DE); Stephan IRLE, Siegen (DE); Erwin THIEL, Siegen (DE)

(73) Assignee: BASF SE, Ludwigshafen (DE)

(21) Appl. No.: 15/533,572

(22) PCT Filed: Dec. 7, 2015
(86) PCT No.: PCT/IB2015/059404

§ 371 Date: Jun. 6, 2017

(30) Foreign Application Priority Data
Dec. 9, 2014 (EP) 14196961.8

(51) Int. Cl. G02B 27/09; G01B 11/22; G01B 11/08; G01B 11/28; G01B 11/00

(52) U.S. Cl. CPC G02B 27/0916; G02B 27/0955; G01B 11/285; G01B 11/002; G01B 11/08; G01B 11/22

(57) ABSTRACT

A detector (110) for an optical detection of at least one object (112) is proposed. The detector (110) comprises: —at least one transfer device (120), wherein the transfer device (120) comprises at least two different focal lengths (140) in response to at least one incident light beam (136); —at least two longitudinal optical sensors (132), wherein each longitudinal optical sensor (132) has at least one sensor region (146), wherein each longitudinal optical sensor (132) is designed to generate at least one longitudinal sensor signal in a manner dependent on an illumination of the sensor region (146) by the light beam (136), wherein the longitudinal sensor signal, given the same total power of the illumination, is dependent on a beam cross-section of the light beam (136) in the sensor region (146), wherein each longitudinal optical sensor (132) exhibits a spectral sensitivity in response to the light beam (136) in a manner that two different longitudinal optical sensors (132) differ with regard to their spectral sensitivity; wherein each optical longitudinal sensor (132) is located at a focal point (138) of the transfer device (120) related to the spectral sensitivity of the respective longitudinal optical sensor (132); and —at least one evaluation device (150), wherein the evaluation device (150) is designed to generate at least one item of information on a longitudinal position and/or at least one item of information on a color of the object (112) by evaluating the longitudinal sensor signal of each longitudinal optical sensor (132). Thereby, a simple and, still, efficient detector for an accurate determining of a position and/or a color of at least one object in space is provided.

### FIELD OF THE INVENTION

The invention relates to a detector for an optical detection of at least one object, in particular, for determining a color and/or a position of at least one object, specifically with regard to a depth or both to the depth and a width of the at least one object. Furthermore, the invention relates to a human-machine interface, an entertainment device, a tracking system and a camera. Further, the invention relates to a method for optical detection of at least one object and to various uses of the detector. Such devices, methods and uses can be employed for example in various areas of daily life, gaming, traffic technology, mapping of spaces, production technology, security technology, medical technology or in the sciences. However, other applications are also possible in principle.

### PRIOR ART

Various optical sensors and photovoltaic devices are known from prior art. While photovoltaic devices are generally used to convert electromagnetic radiation, in particular, ultraviolet, visible or infrared light, into electrical signals or electrical energy, optical detectors are generally used for picking up image information and/or for detecting at least one optical parameter, for example, a brightness.

Various optical sensors which can be based generally on the use of inorganic and/or organic sensor materials are known from prior art. To an increasing extent, in particular for improving large-area processing, sensors comprising at least one organic sensor material are being used, as described for example in US 2007/0176165 A1. In particular, so-called dye solar cells are increasingly of importance, which are described generally, for example in WO 2009/013282 A1.

Various detectors for optically detecting at least one object are known on the basis of such optical sensors. WO 2012/110924 A1 discloses a detector comprising at least one optical sensor, wherein the optical sensor has at least one sensor region. Herein, the optical sensor is designed to generate at least one sensor signal in a manner dependent on an illumination of the sensor region. According to the so-called “FiP effect”, the sensor signal, given the same total power of the illumination, is hereby dependent on a geometry of the illumination, in particular on a beam cross-section of the illumination on the sensor area. The detector furthermore has at least one evaluation device designated to generate at least one item of geometrical information from the sensor signal, in particular at least one item of geometrical information about the illumination and/or the object.

WO 2014/097181 A1 discloses a method and a detector for determining a position of at least one object, by using at least one transversal optical sensor and at least one longitudinal optical sensor. Preferably, a stack of longitudinal optical sensors is employed, in particular to determine a longitudinal position of the object with a high degree of accuracy and without ambiguity. In a particular embodiment therein, at least two of the longitudinal optical sensors differ with regard to their respective spectral sensitivity while the evaluation device is adapted to determine a color of an incident light beam by comparing sensor signals of the longitudinal optical sensors with different spectral sensitivity. Further, an intransparent last longitudinal optical sensor is configured as a white detector which is adapted to absorb light over the whole visible spectral range. Irrespective of the specific color, each beam propagating through the at least two different optical sensors until impinging the intransparent last longitudinal optical sensor, is recorded by at least two different optical sensors. This allows resolving the ambiguity in a known relationship between the beam cross-section of the light beam and the longitudinal position of the object, particularly for each color. Further, WO 2014/097181 A1 discloses a human-machine interface, an entertainment device, a tracking system, and a camera, each comprising at least one such detector for determining a position of at least one object.

Despite the advantages implied by the above-mentioned devices and detectors specifically by the detector disclosed in WO 2014/097181 A1, there still is a need for a simple, cost-efficient and, still, reliable spatial detector which might additionally be able to, preferably simultaneously, detect the color of the object. Thus, an improved spatial resolution of an object in conjunction with the possibility of determining the color of the object in space is desirable.

### Problem Addressed by the Invention

Therefore, a problem addressed by the present invention is that of specifying a device and a method for optically detecting at least one object which at least substantially avoid the disadvantages of known devices and methods of this type. In particular, an improved detector for determining the position and/or the color of an object in space, preferably in a simultaneous manner, is desirable.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used herein, the expressions “have”, “comprise” and “contain” as well as grammatical variations thereof are used in a non-exclusive way. Thus, the expression “A has B” as well as the expression “A comprises B” or “A contains B” may both refer to the fact that, besides B, A contains one or more further components and/or constituents, and to the case in which, besides B, no other components, constituents or elements are present in A.

In a first aspect of the present invention, a detector for optical detection, in particular, for determining a color and/or a position of at least one object, specifically with regard to a depth or to both the depth and a width of the at least one object is disclosed.

The “object” generally may be an arbitrary object, chosen from a living object and a non-living object. Thus, as an example, the at least one object may comprise one or more articles and/or one or more parts of an article. Additionally or alternatively, the object may be or may comprise one or more living beings and/or one or more parts thereof, such as one or more body parts of a human being, e.g. a user, and/or an animal.

As used herein, a “position” generally refers to an arbitrary item of information on a location and/or orientation of the object in space. For this purpose, as an example, one or more coordinate systems may be used, and the position of the object may be determined by using one, two, three or more coordinates. As an example, one or more Cartesian coordinate systems and/or other types of coordinate systems may be used. In one example, the coordinate system may be a coordinate system of the detector in which the detector has a predetermined position and/or orientation. As will be outlined in further detail below, the detector may have an optical axis, which may constitute a main direction of view of the detector. The optical axis may form an axis of the coordinate system, such as a z-axis. Further, one or more additional axes may be provided, preferably perpendicular to the z-axis.

Thus, as an example, the detector may constitute a coordinate system in which the optical axis forms the z-axis and in which, additionally, an x-axis and a y-axis may be provided which are perpendicular to the z-axis and which are perpendicular to each other. As an example, the detector and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

Alternatively, other types of coordinate systems may be used. Thus, as an example, a polar coordinate system may be used in which the optical axis forms a z-axis and in which a distance from the z-axis and a polar angle may be used as additional coordinates. Again, a direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

As used herein, the detector for optical detection generally is a device which is adapted for providing at least one item of information on the position and/or the color of the at least one object. The detector may be a stationary device or a mobile device. Further, the detector may be a stand-alone device or may form part of another device, such as a computer, a vehicle or any other device. Further, the detector may be a hand-held device. Other embodiments of the detector are feasible.

The detector may be adapted to provide the at least one item of information on the position and/or the color of the at least one object in any feasible way. Thus, the information may e.g. be provided electronically, visually, acoustically or in any arbitrary combination thereof. The information may further be stored in a data storage of the detector or a separate device and/or may be provided via at least one interface, such as a wireless interface and/or a wire-bound interface.

The detector comprises:
at least one transfer device, wherein the transfer device comprises at least two different focal lengths in response to at least one incident light beam;
at least two longitudinal optical sensors, wherein each longitudinal optical sensor has at least one sensor region, wherein each longitudinal optical sensor is designed to generate at least one longitudinal sensor signal in a manner dependent on an illumination of the sensor region by the light beam, wherein the longitudinal sensor signal, given the same total power of the illumination, is dependent on a beam cross-section of the light beam in the sensor region, wherein each longitudinal optical sensor exhibits a spectral sensitivity in response to the light beam in a manner that two different longitudinal optical sensors differ with regard to their spectral sensitivity; wherein each longitudinal optical sensor is located at a focal point of the transfer device related to the spectral sensitivity of the respective longitudinal sensor; and
at least one evaluation device, wherein the evaluation device is designed to generate at least one item of information on a longitudinal position and/or at least one item of information on a color of the object by evaluating the longitudinal sensor signal of each longitudinal optical sensor.

Herein, the components listed above may be separate components. Alternatively, two or more of the components as listed above may be integrated into one component. Further, the at least one evaluation device may be formed as a separate evaluation device independent from the transfer device and the longitudinal optical sensors, but may preferably be connected to the longitudinal optical sensors in order to receive the longitudinal sensor signal. Alternatively, the at least one evaluation device may fully or partially be integrated into the longitudinal optical sensors.

As used herein, the “longitudinal optical sensor” is generally a device which is designed to generate at least one longitudinal sensor signal in a manner dependent on an illumination of the sensor region by the light beam, wherein the longitudinal sensor signal, given the same total power of the illumination, is dependent, according to the so-called “FiP effect” on a beam cross-section of the light beam in the sensor region. The longitudinal sensor signal may generally be an arbitrary signal indicative of the longitudinal position, which may also be denoted as a depth. As an example, the longitudinal sensor signal may be or may comprise a digital and/or an analog signal. As an example, the longitudinal sensor signal may be or may comprise a voltage signal and/or a current signal. Additionally or alternatively, the longitudinal sensor signal may be or may comprise digital data. The longitudinal sensor signal may comprise a single signal value and/or a series of signal values. The longitudinal sensor signal may further comprise an arbitrary signal which is derived by combining two or more individual signals, such as by averaging two or more signals and/or by forming a quotient of two or more signals. For potential embodiments of the longitudinal optical sensor and the longitudinal sensor signal, reference may be made to the optical sensor as disclosed in WO 2012/110924 A1.

As will be outlined in further detail below, the detector according to the present invention comprises at least two longitudinal optical sensors, preferably in a sensor stack which may be arranged along the common optical axis of the detector. Thus, preferably, the detector according to the present invention may comprise a stack of longitudinal optical sensors as disclosed in WO 2014/097181 A1, particularly in combination with one or more transversal optical sensors. As an example, one or more transversal optical sensors may be located on a side of the stack of longitudinal optical sensors facing towards the object. Alternatively or additionally, one or more transversal optical sensors may be located on a side of the stack of longitudinal optical sensors facing away from the object. Again, additionally or alternatively, one or more transversal optical sensors may be interposed in between the longitudinal optical sensors of the stack. In a specific embodiment, the at least one transversal optical sensor may be integrated into one of the longitudinal optical sensor, thereby forming a single optical sensor which may be adapted to determine both a longitudinal position and a transversal position of the object. However, embodiments which may only comprise at least two longitudinal optical sensors but no transversal optical sensor may still be possible, such as in a case wherein only determining the depth and/or the color of the object may be desired.

As used herein, the term “transversal optical sensor” generally refers to a device which is adapted to determine a transversal position of at least one light beam traveling from the object to the detector. With regard to the term position, reference may be made to the definition above. Thus, preferably, the transversal position may be or may comprise at least one coordinate in at least one dimension perpendicular to an optical axis of the detector. As an example, the transversal position may be a position of a light spot generated by the light beam in a plane perpendicular to the optical axis, such as on a light-sensitive sensor surface of the transversal optical sensor. As an example, the position in the plane may be given in Cartesian coordinates and/or polar coordinates. Other embodiments are feasible. For potential embodiments of the transversal optical sensor, reference may be made to WO 2014/097181 A1. However, other embodiments are feasible and will be outlined in further detail below.

The transversal optical sensor may provide at least one transversal sensor signal. Herein, the at transversal sensor signal may generally be an arbitrary signal indicative of the transversal position. As an example, the transversal sensor signal may be or may comprise a digital and/or an analog signal. As an example, the transversal sensor signal may be or may comprise a voltage signal and/or a current signal. Additionally or alternatively, the transversal sensor signal may be or may comprise digital data. The transversal sensor signal may comprise a single signal value and/or a series of signal values. The transversal sensor signal may further comprise an arbitrary signal which is derived by combining two or more individual signals, such as by averaging two or more signals and/or by forming a quotient of two or more signals, as will be outlined in further detail below.

As will further be outlined below, preferably, both the longitudinal optical sensor and, if applicable, the longitudinal optical sensor may comprise one or more photo detectors, preferably one or more organic photodetectors and, most preferably, one or more dye-sensitized organic solar cells (DSCs, also referred to as dye solar cells), such as one or more solid dye-sensitized organic solar cells (s-DSCs). Thus, preferably, the detector may comprise one or more DSCs (such as one or more sDSCs) acting as the at least one transversal optical sensor and one or more DSCs (such as one or more sDSCs) acting as the at least one longitudinal optical sensor, preferably a stack of a plurality of DSCs (preferably a stack of a plurality of sDSCs) acting as the at least one longitudinal optical sensor.

Since according to the present invention at least two longitudinal optical sensors are used, wherein the at least two of the longitudinal optical sensors differ with regard to their respective spectral sensitivity, the evaluation device is generally adapted to determine a color of the light beam by comparing sensor signals of the at least two longitudinal optical sensors exhibiting the different spectral sensitivity. As used herein, the expression “determine a color” generally refers to the step of generating at least one item of spectral information about the light beam. The at least one item of spectral information may be selected from the group consisting of a wavelength, specifically a peak wavelength; color coordinates, such as CIE coordinates. As further used herein, a “color” of the light beam generally refers to a spectral composition of the light beam. Specifically, the color of the light beam may be given in any arbitrary color coordinate system and/or in spectral units such as by giving a wavelength of a dominant peak of a spectrum of the light. Other embodiments are feasible. In case the light beam is a narrow-band light beam such as a laser light beam and/or a light beam generated by a semiconductor device such as a light-emitting diode, the peak wavelength of the light beam may be given to characterize the color of the light beam. The determination of the color of the light beam may be performed in various ways which are generally known to the skilled person.

Preferably, the spectral sensitivities of the longitudinal optical sensors may span a coordinate system in color space, and the longitudinal signals provided by the longitudinal optical sensors may provide a coordinate in this color space, as known to the skilled person for example from the way of determining CIE coordinates. As an example, the detector may comprise two, three or more longitudinal optical sensors in a stack. Thereof, at least two, preferably at least three, of the optical sensors may have different spectral sensitivities, whereby three different longitudinal optical sensors with maximum absorption wavelengths in a spectral range between 600 nm and 780 nm (red), between 490 nm and 600 nm (green), and between 380 nm and 490 nm (blue) are generally preferred. Further, the evaluation device may be adapted to generate at least one item of color information for the light beam by evaluating the longitudinal sensor signals of the longitudinal optical sensors having different spectral sensitivities. Consequently, the evaluation device may be adapted to generate at least two color coordinates, preferably at least three color coordinates, wherein each of the color coordinates is determined by dividing a signal of one of the spectrally sensitive optical sensors by a normalization value. As an example, the normalization value may contain a sum of the signals of all spectrally sensitive optical sensors. The at least one item of color information may contain the color coordinates. The at least one item of color information may, as an example, contain CIE coordinates.

As used herein, the term “light” generally refers to electromagnetic radiation in one or more of the visible spectral range, the ultraviolet spectral range and the infrared spectral range. Therein, the term visible spectral range generally refers to a spectral range of 380 nm to 780 nm. The term infrared (IR) spectral range generally refers to electromagnetic radiation in the range of 780 nm to 1000 μm, preferably in the range of 780 nm to 3.0 μm. The term ultraviolet spectral range generally refers to electromagnetic radiation in the range of 1 nm to 380 nm, preferably in the range of 100 nm to 380 nm. Preferably, light as used within the present invention is visible light, i.e. light in the visible spectral range.

The term “light beam” generally refers to an amount of light emitted into a specific direction. Thus, the light beam may be a bundle of the light rays having a predetermined extension in a direction perpendicular to a direction of propagation of the light beam. Preferably, the light beam may be or may comprise one or more Gaussian light beams which may be characterized by one or more Gaussian beam parameters, such as one or more of a beam waist, a Rayleigh-length or any other beam parameter or combination of beam parameters suited to characterize a development of a beam diameter and/or a beam propagation in space.

In addition, the detector comprises at least one transfer device, such as an optical lens, which will be described later in more detail, and which may further be arranged along the common optical axis. Most preferably, the light beam which emerges from the object may in this case travel first through the at least one transfer device and thereafter through the stack of the transparent longitudinal optical sensors until it finally impinges on the imaging device. As used herein, the term “transfer device” refers to an optical element which is configured to transfer the at least one light beam emerging from the object to optical sensors within the detector, i.e. the at least two longitudinal optical sensors and the at least one optional transversal optical sensor. Thus, the transfer device can be designed to feed light propagating from the object to the detector to the optical sensors, wherein this feeding can optionally be effected by means of imaging or else by means of non-imaging properties of the transfer device. In particular the transfer device can also be designed to collect the electromagnetic radiation before the latter is fed to the transversal and/or longitudinal optical sensor.

In addition, the at least one transfer device has imaging properties. Consequently, the transfer device comprises at least one imaging element, for example at least one lens and/or at least one curved mirror, since, in the case of such imaging elements, for example, a geometry of the illumination on the sensor region can be dependent on a relative positioning, for example a distance, between the transfer device and the object. As used herein, the transfer device is designed in such a way that the electromagnetic radiation which emerges from the object is transferred completely to the sensor region, for example is focused completely onto the sensor region, in particular the sensor area, in particular if the object is arranged in a visual range of the detector.

According to the present invention, the transfer device exhibits at least two different focal lengths in response to at least one incident light beam, wherein, in particular, the different focal lengths of the transfer device differ with respect to a wavelength of the at least one incident light beam. As used herein, the term “focal length” of the transfer device refers to a distance over which incident collimated rays which may impinge the transfer device are brought into a focus which may also be denoted as “focal point”. Thus, the focal length constitutes a measure of an ability of the transfer device to converge an impinging light beam. Thus, the transfer device may comprise one or more imaging elements which can have the effect of a converging lens. By way of example, the optional transfer device can have one or more lenses, in particular one or more refractive lenses, and/or one or more convex mirrors. In this example, the focal length may be defined as a distance from the center of the thin refractive lens to the principal focal points of the thin lens. For a converging thin refractive lens, such as a convex or biconvex thin lens, the focal length may be considered as being positive and may provide the distance at which a beam of collimated light impinging the thin lens as the transfer device may be focused into a single spot. Additionally, the transfer device can comprise at least one wavelength-selective element, for example at least one optical filter. Additionally, the transfer device can be designed to impress a predefined beam profile on the electromagnetic radiation, for example, at the location of the sensor region and in particular the sensor area. The abovementioned optional embodiments of the optional transfer device can, in principle, be realized individually or in any desired combination.

As already mentioned, the transfer device exhibits at least two different focal lengths in response to at least one incident light beam. Particularly in the case where the transfer device comprises a refractive lens, the different focal lengths in the transfer device may be created by a chromatic aberration caused by a material used in the transfer device. Further, the different focal lengths can be caused by a nanostructured separate element, such as a periodic grating, or a nanostructured surface of a part of the lens. Alternatively or in addition, the different focal lengths in the transfer device may be created by at least two different areas which may be arranged at different locations within the transfer device. Herein, each area may comprise a specific focal length such that two different areas may differ from each other by a value of their respective focal length. For this purpose, the transfer device may comprise one or more multifocal lenses. Herein, the different areas may directly adjoin each other, thereby providing an abrupt change of the focal length between two adjoining areas for an impinging light beam. This embodiment may particularly be useful to adjust the number of focal points as provided by the transfer device with the number of longitudinal optical sensors within the detector.

However, in order to avoid the described abrupt change of the focal length between neighboring areas, the transfer device may further comprise transition regions between adjoining areas. Herein, in each transition region the focal length may vary between the focal lengths of the adjoining areas, preferably in a smooth or monotonous manner. For this purpose, the transfer device may comprise one or more progressive lenses. This embodiment may particularly be useful in order to allow a higher resolution of the device with respect to the color of the object, such as in a case wherein only two or three longitudinal optical sensors which may be movable along the optical axis may be present, or, as a further case, wherein more than two or three longitudinal optical sensors may be present.

As used herein, the term “evaluation device” generally refers to an arbitrary device designed to generate the items of information, i.e. the at least one item of information on the color of the object and/or the at least one item of information on the position of the object. As an example, the evaluation device may be or may comprise one or more integrated circuits, such as one or more application-specific integrated circuits (ASICs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the sensor signals, such as one or more AD-converters and/or one or more filters. As used herein, the sensor signal may generally refer to one of the longitudinal sensor signal and, if applicable, to the transversal sensor signal. Further, the evaluation device may comprise one or more data storage devices. Further, as outlined above, the evaluation device may comprise one or more interfaces, such as one or more wireless interfaces and/or one or more wire-bound interfaces.

The at least one evaluation device may be adapted to perform at least one computer program, such as at least one computer program performing or supporting the step of generating the items of information. As an example, one or more algorithms may be implemented which, by using the sensor signals as input variables, may perform a predetermined transformation into the color and/or the position of the object.

The evaluation device may particularly comprise at least one data processing device, in particular an electronic data processing device, which can be designed to generate the items of information by evaluating the sensor signals. Thus, the evaluation device is designed to use the sensor signals as input variables and to generate the items of information on the transversal position and the longitudinal position of the object by processing these input variables. The processing can be done in parallel, subsequently or even in a combined manner. The evaluation device may use an arbitrary process for generating these items of information, such as by calculation and/or using at least one stored and/or known relationship. Besides the sensor signals, one or a plurality of further parameters and/or items of information can influence said relationship, for example at least one item of information about a modulation frequency. The relationship can be determined or determinable empirically, analytically or else semi-empirically. Particularly preferably, the relationship comprises at least one calibration curve, at least one set of calibration curves, at least one function or a combination of the possibilities mentioned. One or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the sensor signals into the items of information may be used. Alternatively, at least one combined relationship for processing the sensor signals is feasible. Various possibilities are conceivable and can also be combined.

By way of example, the evaluation device can be designed in terms of programming for the purpose of determining the items of information. The evaluation device can comprise in particular at least one computer, for example at least one microcomputer. Furthermore, the evaluation device can comprise one or a plurality of volatile or nonvolatile data memories. As an alternative or in addition to a data processing device, in particular at least one computer, the evaluation device can comprise one or a plurality of further electronic components which are designed for determining the items of information, for example an electronic table and in particular at least one look-up table and/or at least one application-specific integrated circuit (ASIC).

The detector has, as described above, at least one evaluation device. In particular, the at least one evaluation device can also be designed to completely or partly control or drive the detector, for example by the evaluation device being designed to control one or a plurality of modulation devices of the detector and/or to control at least one illumination source of the detector. The evaluation device can be designed, in particular, to carry out at least one measurement cycle in which one or a plurality of sensor signals, such as a plurality of sensor signals, are picked up, for example a plurality of sensor signals of successively at different modulation frequencies of the illumination.

The evaluation device is designed, as described above, to generate at least one item of information on the position and/or the color of the object by evaluating the respective sensor signals. Said position of the object can be static or may even comprise at least one movement of the object, for example a relative movement between the detector or parts thereof and the object or parts thereof. In this case, a relative movement can generally comprise at least one linear movement and/or at least one rotational movement. Items of movement information can for example also be obtained by comparison of at least two items of information picked up at different times, such that for example at least one item of location information can also comprise at least one item of velocity information and/or at least one item of acceleration information, for example at least one item of information about at least one relative velocity between the object or parts thereof and the detector or parts thereof. In particular, the at least one item of location information can generally be selected from: an item of information about a distance between the object or parts thereof and the detector or parts thereof, in particular an optical path length; an item of information about a distance or an optical distance between the object or parts thereof and the optional transfer device or parts thereof; an item of information about a positioning of the object or parts thereof relative to the detector or parts thereof; an item of information about an orientation of the object and/or parts thereof relative to the detector or parts thereof; an item of information about a relative movement between the object or parts thereof and the detector or parts thereof; an item of information about a two-dimensional or three-dimensional spatial configuration of the object or of parts thereof, in particular a geometry or form of the object. Generally, the at least one item of location information can therefore be selected for example from the group consisting of: an item of information about at least one location of the object or at least one part thereof; information about at least one orientation of the object or a part thereof; an item of information about a geometry or form of the object or of a part thereof, an item of information about a velocity of the object or of a part thereof, an item of information about an acceleration of the object or of a part thereof, an item of information about a presence or absence of the object or of a part thereof in a visual range of the detector.

The at least one item of location information can be specified for example in at least one coordinate system, for example a coordinate system in which the detector or parts thereof rest. Alternatively or additionally, the location information can also simply comprise for example a distance between the detector or parts thereof and the object or parts thereof. Combinations of the possibilities mentioned are also conceivable.

As outlined above, preferably, the transversal optical sensor is a photo detector having at least one first electrode, at least one second electrode and at least one photovoltaic material, wherein the photovoltaic material is embedded in between the first electrode and the second electrode. As used herein, a “photovoltaic material” generally is a material or combination of materials adapted to generate electric charges in response to an illumination of the photovoltaic material with light.

Preferably, one of the electrodes of the transversal optical sensor may be a split electrode having at least two partial electrodes, wherein the transversal optical sensor has a sensor area, wherein the at least one transversal sensor signal indicates a position of the light beam in the sensor area. Thus, as outlined above, the transversal optical sensor may be or may comprise one or more photo detectors, preferably one or more organic photo detectors, more preferably one or more DSCs or sDSCs. The sensor area may be a surface of the photo detector facing towards the object. The sensor area preferably may be oriented perpendicular to the optical axis. Thus, the transversal sensor signal may indicate a position of a light spot generated by the light beam in a plane of the sensor area of the transversal optical sensor.

Generally, as used herein, the term “partial electrode” refers to an electrode out of a plurality of electrodes, adapted for measuring at least one current and/or voltage signal, preferably independent from other partial electrodes. Thus, in case a plurality of partial electrodes is provided, the respective electrode is adapted to provide a plurality of electric potentials and/or electric currents and/or voltages via the at least two partial electrodes, which may be measured and/or used independently.

The transversal optical sensor may further be adapted to generate the transversal sensor signal in accordance with the electrical currents through the partial electrodes. Thus, a ratio of electric currents through two horizontal partial electrodes may be formed, thereby generating an x-coordinate, and/or a ratio of electric currents through to vertical partial electrodes may be formed, thereby generating a y-coordinate. The detector, preferably the transversal optical sensor and/or the evaluation device, may be adapted to derive the information on the transversal position of the object from at least one ratio of the currents through the partial electrodes. Other ways of generating position coordinates by comparing currents through the partial electrodes are feasible.

The partial electrodes may generally be defined in various ways, in order to determine a position of the light beam in the sensor area. Thus, two or more horizontal partial electrodes may be provided in order to determine a horizontal coordinate or x-coordinate, and two or more vertical partial electrodes may be provided in order to determine a vertical coordinate or y-coordinate. Thus, the partial electrodes may be provided at a rim of the sensor area, wherein an interior space of the sensor area remains free and may be covered by one or more additional electrode materials. As will be outlined in further detail below, the additional electrode material preferably may be a transparent additional electrode material, such as a transparent metal and/or a transparent conductive oxide and/or, most preferably, a transparent conductive polymer.

Further embodiments refer to relationships between the transversal optical sensor and the longitudinal optical sensor. In a specific embodiment, the at least one transversal optical sensor may be integrated into one of the longitudinal optical sensor, thereby forming a single optical sensor which may be adapted to determine both the longitudinal position and the transversal position of the object. Thus, in principle, the transversal optical sensor and the longitudinal optical sensor at least partially may be identical. Preferably, however, the transversal optical sensor and the longitudinal optical sensor at least partially may be independent optical sensors, such as independent photo detectors and, more preferably, independent DSCs or sDSCs.

By using the transversal optical sensor or the single optical sensor, wherein one of the electrodes is a split electrode with three or more partial electrodes, currents through the partial electrodes may be dependent on a position of the light beam in the sensor area. This may generally be due to the fact that Ohmic losses or resistive losses may occur on the way from a location of generation of electrical charges due to the impinging light onto the partial electrodes. Thus, besides the partial electrodes, the split electrode may comprise one or more additional electrode materials connected to the partial electrodes, wherein the one or more additional electrode materials provide an electrical resistance. Thus, due to the Ohmic losses on the way from the location of generation of the electric charges to the partial electrodes through with the one or more additional electrode materials, the currents through the partial electrodes depend on the location of the generation of the electric charges and, thus, to the position of the light beam in the sensor area. For details of this principle of determining the position of the light beam in the sensor area, reference may be made to the preferred embodiments below and/or to the physical principles and device options as disclosed in WO 2014/097181 A1 and the respective references therein.

Further preferred embodiments may refer to the photovoltaic material. Thus, the photovoltaic material of the transversal optical sensor may comprise at least one organic photovoltaic material. Thus, generally, the transversal optical sensor may be an organic photo detector. Preferably, the organic photo detector may be a dye-sensitized solar cell. The dye-sensitized solar cell preferably may be a solid dye-sensitized solar cell, comprising a layer setup embedded in between the first electrode and the second electrode, the layer setup comprising at least one n-semiconducting metal oxide, at least one dye, and at least one solid p-semiconducting organic material.

According to the present invention, the detector comprises at least two longitudinal optical sensors, each longitudinal optical sensor being adapted to generate at least one longitudinal sensor signal. Herein, preferably all longitudinal optical sensors of the detector, which may be arranged in form of a stack along the optical axis of the detector, are transparent. Thus, the light beam may pass through a first transparent longitudinal optical sensor before impinging on the other longitudinal optical sensors, preferably subsequently. Thus, the light beam from the object may subsequently reach all longitudinal optical sensors.

Further embodiments of the present invention referred to the nature of the light beam which propagates from the object to the detector. The light beam might be admitted by the object itself, i.e. might originate from the object. Additionally or alternatively, another origin of the light beam is feasible. Thus, as will be outlined in further detail below, one or more illumination sources might be provided which illuminate the object, such as by using one or more primary rays or beams, such as one or more primary rays or beams having a predetermined characteristic. In the latter case, the light beam propagating from the object to the detector might be a light beam which is reflected by the object and/or a reflection device connected to the object.

As outlined above, the at least one longitudinal sensor signal, given the same total power of the illumination by the light beam, is, according to the FiP effect, dependent on a beam cross-section of the light beam in the sensor region of the at least one longitudinal optical sensor. As used herein, the term beam cross-section generally refers to a lateral extension of the light beam or a light spot generated by the light beam at a specific location. In case a circular light spot is generated, a radius, a diameter or a Gaussian beam waist or twice the Gaussian beam waist may function as a measure of the beam cross-section. In case non-circular light-spots are generated, the cross-section may be determined in any other feasible way, such as by determining the cross-section of a circle having the same area as the non-circular light spot, which is also referred to as the equivalent beam cross-section.

Thus, given the same total power of the illumination of the sensor region by the light beam, a light beam having a first beam diameter or beam cross-section may generate a first longitudinal sensor signal, whereas a light beam having a second beam diameter or beam-cross section being different from the first beam diameter or beam cross-section generates a second longitudinal sensor signal being different from the first longitudinal sensor signal. Thus, by comparing the longitudinal sensor signals, at least one item of information on the beam cross-section, specifically on the beam diameter, may be generated. For details of this effect, reference may be made to WO 2012/110924 A1. Specifically in case one or more beam properties of the light beam propagating from the object to the detector are known, the at least one item of information on the longitudinal position of the object may thus be derived from a known relationship between the at least one longitudinal sensor signal and a longitudinal position of the object. The known relationship may be stored in the evaluation device as an algorithm and/or as one or more calibration curves. As an example, specifically for Gaussian beams, a relationship between a beam diameter or beam waist and a position of the object may easily be derived by using the Gaussian relationship between the beam waist and a longitudinal coordinate.

Generally, the detector may further comprise at least one imaging device, i.e. a device capable of acquiring at least one image. The imaging device can be embodied in various ways. Thus, the imaging device can be for example part of the detector in a detector housing. Alternatively or additionally, however, the imaging device can also be arranged outside the detector housing, for example as a separate imaging device. Alternatively or additionally, the imaging device can also be connected to the detector or even be part of the detector. In a preferred arrangement, the stack of the transparent longitudinal optical sensors and the imaging device are aligned along a common optical axis along which the light beam travels. Thus, it may be possible to locate an imaging device in the optical path of the light beam in a manner that the light beam travels through the stack of the transparent longitudinal optical sensors until it impinges on the imaging device. However, other arrangements are possible.

As used herein, an “imaging device” is generally understood as a device which can generate a one-dimensional, a two-dimensional, or a three-dimensional image of the object or of a part thereof. In particular, the detector, with or without the at least one optional imaging device, can be completely or partly used as a camera, such as an IR camera, or an RGB camera, i.e. a camera which is designed to deliver three basic colors which are designated as red, green, and blue, on three separate connections. Thus, as an example, the at least one imaging device may be or may comprise at least one imaging device selected from the group consisting of: a pixelated organic camera element, preferably a pixelated organic camera chip; a pixelated inorganic camera element, preferably a pixelated inorganic camera chip, more preferably a CCD- or CMOS-chip; a monochrome camera element, preferably a monochrome camera chip; a multicolor camera element, preferably a multicolor camera chip; a full-color camera element, preferably a full-color camera chip. The imaging device may be or may comprise at least one device selected from the group consisting of a monochrome imaging device, a multi-chrome imaging device and at least one full color imaging device. A multi-chrome imaging device and/or a full color imaging device may be generated by using filter techniques and/or by using intrinsic color sensitivity or other techniques, as the skilled person will recognize. Other embodiments of the imaging device are also possible.

The imaging device may be designed to image a plurality of partial regions of the object successively and/or simultaneously. By way of example, a partial region of the object can be a one-dimensional, a two-dimensional, or a three-dimensional region of the object which is delimited for example by a resolution limit of the imaging device and from which electromagnetic radiation emerges. In this context, imaging should be understood to mean that the electromagnetic radiation which emerges from the respective partial region of the object is fed into the imaging device, for example by means of the at least one optional transfer device of the detector. The electromagnetic rays can be generated by the object itself, for example in the form of a luminescent radiation. Alternatively or additionally, the at least one detector may comprise at least one illumination source for illuminating the object.

In particular, the imaging device can be designed to image sequentially, for example by means of a scanning method, in particular using at least one row scan and/or line scan, the plurality of partial regions sequentially. However, other embodiments are also possible, for example embodiments in which a plurality of partial regions is simultaneously imaged. The imaging device is designed to generate, during this imaging of the partial regions of the object, signals, preferably electronic signals, associated with the partial regions. The signal may be an analogue and/or a digital signal. By way of example, an electronic signal can be associated with each partial region. The electronic signals can accordingly be generated simultaneously or else in a temporally staggered manner. By way of example, during a row scan or line scan, it is possible to generate a sequence of electronic signals which correspond to the partial regions of the object, which are strung together in a line, for example. Further, the imaging device may comprise one or more signal processing devices, such as one or more filters and/or analogue-digital-converters for processing and/or preprocessing the electronic signals.

Light emerging from the object can originate in the object itself, but can also optionally have a different origin and propagate from this origin to the object and subsequently toward the optical sensors. The latter case can be effected for example by at least one illumination source being used. The illumination source can be embodied in various ways. Thus, the illumination source can be for example part of the detector in a detector housing. Alternatively or additionally, however, the at least one illumination source can also be arranged outside a detector housing, for example as a separate light source. The illumination source can be arranged separately from the object and illuminate the object from a distance. Alternatively or additionally, the illumination source can also be connected to the object or even be part of the object, such that, by way of example, the electromagnetic radiation emerging from the object can also be generated directly by the illumination source. By way of example, at least one illumination source can be arranged on and/or in the object and directly generate the electromagnetic radiation by means of which the sensor region is illuminated. This illumination source can for example be or comprise an ambient light source and/or may be or may comprise an artificial illumination source. By way of example, at least one infrared emitter and/or at least one emitter for visible light and/or at least one emitter for ultraviolet light can be arranged on the object. By way of example, at least one light emitting diode and/or at least one laser diode can be arranged on and/or in the object. The illumination source can comprise in particular one or a plurality of the following illumination sources: a laser, in particular a laser diode, although in principle, alternatively or additionally, other types of lasers can also be used; a light emitting diode; an incandescent lamp; an organic light source, in particular an organic light emitting diode; a structured light source. Alternatively or additionally, other illumination sources can also be used. It is particularly preferred if the illumination source is designed to generate one or more light beams having a Gaussian beam profile, as is at least approximately the case for example in many lasers. For further potential embodiments of the optional illumination source, reference may be made to one of WO 2012/110924 A1 and WO 2014/097181 A1. Still, other embodiments are feasible.

The at least one optional illumination source generally may emit light in at least one of: the ultraviolet spectral range, preferably in the range of 200 nm to 380 nm; the visible spectral range (380 nm to 780 nm); the infrared spectral range, preferably in the range of 780 nm to 3.0 micrometers. Most preferably, the at least one illumination source is adapted to emit light in the visible spectral range, preferably in the range of 500 nm to 780 nm, most preferably at 650 nm to 750 nm or at 690 nm to 700 nm. Herein, it is particularly preferred when the illumination source may exhibit a spectral range which may be related to the spectral sensitivities of the longitudinal sensors, particularly in a manner to ensure that the longitudinal sensor which may be illuminated by the respective illumination source may provide a sensor signal with a high intensity which may, thus, enable a high-resolution evaluation with a sufficient signal-to-noise-ratio.

Furthermore, the detector can have at least one modulation device for modulating the illumination, in particular for a periodic modulation, in particular a periodic beam interrupting device. A modulation of the illumination should be understood to mean a process in which a total power of the illumination is varied, preferably periodically, in particular with one or a plurality of modulation frequencies. In particular, a periodic modulation can be effected between a maximum value and a minimum value of the total power of the illumination. The minimum value can be 0, but can also be >0, such that, by way of example, complete modulation does not have to be effected. The modulation can be effected for example in a beam path between the object and the optical sensor, for example by the at least one modulation device being arranged in said beam path. Alternatively or additionally, however, the modulation can also be effected in a beam path between an optional illumination source—described in even greater detail below—for illuminating the object and the object, for example by the at least one modulation device being arranged in said beam path. A combination of these possibilities is also conceivable. The at least one modulation device can comprise for example a beam chopper or some other type of periodic beam interrupting device, for example comprising at least one interrupter blade or interrupter wheel, which preferably rotates at constant speed and which can thus periodically interrupt the illumination. Alternatively or additionally, however, it is also possible to use one or a plurality of different types of modulation devices, for example modulation devices based on an electro-optical effect and/or an acousto-optical effect. Once again alternatively or additionally, the at least one optional illumination source itself can also be designed to generate a modulated illumination, for example by said illumination source itself having a modulated intensity and/or total power, for example a periodically modulated total power, and/or by said illumination source being embodied as a pulsed illumination source, for example as a pulsed laser. Thus, by way of example, the at least one modulation device can also be wholly or partly integrated into the illumination source. Various possibilities are conceivable.

Accordingly, the detector can be designed in particular to detect at least two longitudinal sensor signals in the case of different modulations, in particular at least two longitudinal sensor signals at respectively different modulation frequencies. The evaluation device can be designed to generate the geometrical information from the at least two longitudinal sensor signals. As described in WO 2012/110924 A1 and WO 2014/097181 A1, it is possible to resolve ambiguities and/or it is possible to take account of the fact that, for example, a total power of the illumination is generally unknown. By way of example, the detector can be designed to bring about a modulation of the illumination of the object and/or at least one sensor region of the detector, such as at least one sensor region of the at least one longitudinal optical sensor, with a frequency of 0.05 Hz to 1 MHz, such as 0.1 Hz to 10 kHz. As outlined above, for this purpose, the detector may comprise at least one modulation device, which may be integrated into the at least one optional illumination source and/or may be independent from the illumination source. Thus, at least one illumination source might, by itself, be adapted to generate the above-mentioned modulation of the illumination, and/or at least one independent modulation device may be present, such as at least one chopper and/or at least one device having a modulated transmissibility, such as at least one electro-optical device and/or at least one acousto-optical device.

As outlined above, the detector has a plurality of longitudinal optical sensors. Preferably, the plurality of longitudinal optical sensors is stacked, such as along the optical axis of the detector. Thus, the longitudinal optical sensors may form a longitudinal optical sensor stack. The longitudinal optical sensor stack may preferably be oriented in a manner that the sensor regions of the longitudinal optical sensors are oriented perpendicular to the optical axis. Thus, as an example, the sensor areas or the sensor surfaces of the longitudinal optical sensors may be oriented in parallel, wherein slight angular tolerances might be tolerable, such as angular tolerances of no more than 10°, preferably of no more than 5°.

In a preferred embodiment, the at least one transversal optical sensor may preferably fully or partially located on a side of the stacked longitudinal optical sensors facing the object. However, other embodiments are feasible, such as embodiments in which the at least one transversal optical sensor is fully or partially located on a side of the transversal optical sensor stack facing away from the object. Again, additionally or alternatively, embodiments are feasible in which the at least one transversal optical sensor is located fully or partially in between the longitudinal optical sensor stack.

As mentioned above, the detector according to the present invention comprises at least two longitudinal optical sensors, preferably at least three longitudinal optical sensors, which may be arranged in the stacked fashion and/or in another arrangement but also four, five, six or more longitudinal optical sensors may be useful according to the desired purpose. Further according to the present invention, the longitudinal optical sensors differ by their respective spectral sensitivities. As used herein, the term “spectral sensitivity” generally refers to the observation that the longitudinal sensor signal of the longitudinal optical sensor, for the same power of the light beam, may vary with the wavelength of the light beam. Thus, for each longitudinal optical sensor the amplitude of the longitudinal sensor signal can be illustrated as a function of the wavelength of the incident light beam. Thus, generally, the at least two of the optical sensors may differ with regard to their spectral properties, i.e. the corresponding the longitudinal sensor signal may exhibit different amplitudes with respect to the wavelength of the incident light beam. By way of example, the detector may comprise three longitudinal optical sensors in a stack, wherein the three different longitudinal optical sensors may exhibit maximum absorption wavelengths in a spectral range between 600 nm and 780 nm (red), between 490 nm and 600 nm (green), and between 380 nm and 490 nm (blue), respectively. However, other kinds of colors, such as cyan, magenta, and yellow, may be used. Further, other examples comprising two, three, four or more longitudinal optical sensors may be possible.

The different spectral sensitivities of the longitudinal optical sensors can, generally, be achieved by using different types of transparent substrates. Herein, the substrates employed for longitudinal optical sensors may differ from each other, in particular, with regard to a geometrical quantity and/or a material quantity related to the substrates, such as the thickness, the shape, and/or the refractive index of each substrate. A particular preferred example comprises a use of different absorbing materials for the longitudinal optical sensors, such as of different types of dyes. Additionally, the thickness of some substrates or of each substrate, which may be defined by the light path as traversed by the light beam travelling through the respective substrate, may be varied. In addition or alternatively, the substrates employed for the longitudinal optical sensors may differ by exhibiting a different shape which may be selected from the group comprising a planar, a planar-convex, a planar-concave, a biconvex, a biconcave or any other form which may be employed for optical purposes, such as lenses or prisms. Herein, the substrates may be rigid or else flexible. Suitable substrates are, as well as metal foils, in particular plastic sheets or films and especially glass sheets or glass films. Shape-changing materials, such as shape-changing polymers, constitute an example of materials which may be employed as flexible substrates. Furthermore, the substrate may be covered or coated, in particular, for the purpose of reducing and/or modifying reflections of the incident light beam.

The longitudinal optical sensors preferably are arranged such that a light beam from the object illuminates all longitudinal optical sensors, preferably sequentially. Specifically in this case, preferably, at least one longitudinal sensor signal is generated by each longitudinal optical sensor. This embodiment is specifically preferred since the stacked setup of the longitudinal optical sensors allows for an easy and efficient normalization of the signals, even if an overall power or intensity of the light beam is unknown. Thus, the single longitudinal sensor signals may be known to be generated by one and the same light beam. Thus, the evaluation device may be adapted to normalize the longitudinal sensor signals and to generate the information on the longitudinal position of the object independent from an intensity of the light beam. For this purpose, use may be made of the fact that, in case the single longitudinal sensor signals are generated by one and the same light beam, differences in the single longitudinal sensor signals are only due to differences in the cross-sections of the light beam at the location of the respective sensor regions of the single longitudinal optical sensors. Thus, by comparing the single longitudinal sensor signals, information on a beam cross-section may be generated even if the overall power of the light beam is unknown. From the beam cross-section, information regarding the longitudinal position of the object may be gained, specifically by making use of the known relationship between the cross-section of the light beam and the longitudinal position of the object.

In a particularly preferred embodiment of the present invention, the detector additionally comprises at least two secondary longitudinal optical sensors. With the notable exception in respect to their position within the detector, the secondary longitudinal optical sensors generally exhibit the same or similar properties as the longitudinal optical sensors. Therefore, for acquiring further information on details of the secondary longitudinal optical sensors reference may be made to a respective property of the longitudinal optical sensor. Thus, in particular, each secondary longitudinal optical sensor has at least one sensor region, wherein each secondary longitudinal optical sensor is designed to generate at least one longitudinal sensor signal in a manner dependent on an illumination of the sensor region by the light beam. As a consequence, the longitudinal sensor signal, given the same total power of the illumination, is dependent on a beam cross-section of the light beam in the sensor region. As a result, the evaluation device may further be designed to generate at least one item of information on the longitudinal position of the object by evaluating the longitudinal sensor signal of each secondary longitudinal optical sensor, thus taking into account an additional piece of information as provided by each secondary optical longitudinal sensor.

Further, each secondary optical longitudinal sensor may exhibit a spectral sensitivity in response to the light beam in a manner that two secondary longitudinal optical sensors may differ with regard to their spectral sensitivity. Such an effect may be achieved in the same or a similar manner as within the longitudinal optical sensors. In a particularly preferred embodiment, each secondary longitudinal optical sensor may comprise the same spectral sensitivity as one of the longitudinal optical sensors. In this embodiment, the detector may, thus, comprise at least two longitudinal optical sensors which may exhibit the same or a similar spectral sensitivity, i.e. one longitudinal optical sensor and one secondary longitudinal optical sensor. As used herein, the “same or a similar spectral sensitivity” may be understood that the longitudinal sensor signal of the respective secondary longitudinal optical sensor is the same or similar to the longitudinal sensor signal of the corresponding secondary longitudinal optical sensor with respect to the wavelength of the incident light beam. Thus, the amplitude of the secondary longitudinal sensor signal for each secondary longitudinal optical sensor can be described as a function of the wavelength of the incident light beam. By way of example, the three different secondary longitudinal optical sensors may exhibit maximum absorption wavelengths in the red, green, or blue spectral range as defined above, respectively, in the same manner as the three corresponding different longitudinal optical sensors to which they are compared. However, other examples comprising two, three, four or more secondary longitudinal optical sensors may be possible.

In a further preferred embodiment, the secondary longitudinal optical sensors which exhibit different spectral sensitivities may be arranged as at least one secondary stack in the detector in the same manner as the stack-like arrangement of longitudinal optical sensors having different spectral sensitivities. In particular, the longitudinal optical sensors of the detector may form a single stack while the secondary longitudinal optical sensors may form also form a single secondary stack or, alternatively, more than one separate secondary stacks, such as two secondary stacks which may be arranged in form of a first secondary stack and a second secondary stack. In the latter embodiment, the single stack of the longitudinal optical sensors may be located along the optical axis, in particular, between the first secondary stack and the second secondary stack, preferably in an equidistant manner. However, other arrangements of the mentioned stacks may be possible. By way of example, the detector may comprise a single stack of longitudinal optical sensors and one or two secondary stacks of secondary longitudinal optical sensors, wherein each stack and each secondary stack may, preferably, comprise the same number of longitudinal optical sensors and secondary longitudinal optical sensors, respectively. More preferred, each stack and each secondary stack may comprise three longitudinal optical sensors and secondary longitudinal optical sensors, respectively, which may exhibit their maximum absorption wavelengths within the red, green, or blue spectral range. Preferably, the arrangement of the mentioned stacks may be such that an incident light beam might always impinge the longitudinal optical sensors and the secondary longitudinal optical sensors, respectively, in the same order with regard to their spectral sensitivity, e.g. first the sensor which is sensitive in the red spectral range, followed by the sensor which is sensitive in the green spectral range, and finally the sensor which is sensitive in the blue spectral range. Further, mixed assemblies comprising different colors may also be possible, such as a sequence of optical sensors with the respective sensitivity in a repeated order, such as red-green-blue-red-green-blue, or other arrangements. However, other combinations are possible, such as embodiments with a different number of longitudinal optical sensors, e.g. two, four or more longitudinal optical sensors within the stack, and/or with different colors of longitudinal optical sensors, e.g. cyan, magenta, and yellow, or other combinations of colors, which may occur in an identical or similar manner within each stack or each secondary stack.

In a further preferred embodiment, each secondary longitudinal optical sensor may, thus, be located near the focal point of the transfer device related to the spectral sensitivity of the respective secondary longitudinal optical sensor. This arrangement may particularly reflect the situation that, since each longitudinal optical sensor is already located at the focal point of the transfer device related to the spectral sensitivity of the respective longitudinal optical sensor, the locations at the respective focal points of the transfer device are already occupied by the longitudinal optical sensors of the detector. However, other arrangements may be possible, in particular, an arrangement where each secondary longitudinal optical sensor may be located in a respective distance from the focal points of the employed transfer device.

Further, the longitudinal sensor signals generated by the longitudinal optical sensors may be compared, in order to gain information on the total power and/or intensity of the light beam and/or in order to normalize the longitudinal sensor signals and/or the at least one item of information on the longitudinal position of the object for the total power and/or total intensity of the light beam. Thus, as an example, a maximum value of the longitudinal optical sensor signals may be detected, and all longitudinal sensor signals may be divided by this maximum value, thereby generating normalized longitudinal optical sensor signals, which, then, may be transformed by using the above-mentioned known relationship, into the at least one item of longitudinal information on the object. Other ways of normalization are feasible, such as a normalization using a mean value of the longitudinal sensor signals and dividing all longitudinal sensor signals by the mean value. Other options are possible. Each of these options may be suited to render the transformation independent from the total power and/or intensity of the light beam. In addition, information on the total power and/or intensity of the light beam might, thus, be generated.

In a further preferred embodiment of the present invention, the longitudinal sensor signals as generated by the secondary longitudinal optical sensors may be taken into account when determining the at least one item of information on the longitudinal position of the object. For this purpose, the evaluation device may be adapted to compare the longitudinal sensor signal of at least one of the longitudinal optical sensors with the longitudinal sensor signal of at least one of the secondary longitudinal optical sensors, in particular, by comparing the longitudinal sensor signal of a specific longitudinal optical sensor with the longitudinal sensor signal of that secondary longitudinal optical sensor which exhibits the same spectral sensitivity as the selected longitudinal optical sensor.

This embodiment may, particularly, be used by the evaluation device in order to resolve an ambiguity in the known relationship between a beam cross-section of the light beam and the longitudinal position of the object. Thus, even if the beam properties of the light beam propagating from the object to the detector are known fully or partially, it is known that, in many beams, the beam cross-section narrows before reaching a focal point and, afterwards, widens again. Thus, before and after the focal point in which the light beam has the narrowest beam cross-section, positions along the axis of propagation of the light beam occur in which the light beam has the same cross-section. Thus, as an example, at a distance z0 before and after the focal point, the cross-section of the light beam is identical. Thus, in case only one longitudinal optical sensor with a specific spectral sensitivity is used, a specific cross-section of the light beam might be determined, in case the overall power or intensity of the light beam is known. By using this information, the distance z0 of the respective longitudinal optical sensor from the focal point might be determined. However, in order to determine whether the respective longitudinal optical sensor is located before or behind the focal point, additional information is required, such as a history of movement of the object and/or the detector and/or information on whether the detector is located before or behind the focal point. In typical situations, this additional information may not be provided. Therefore, by using at least two longitudinal optical sensors with the same or similar spectral sensitivity, additional information may be gained in order to resolve the above-mentioned ambiguity. Thus, in case the evaluation device, by evaluating the longitudinal sensor signals, recognizes that the beam cross-section of the light beam on a first longitudinal optical sensor is larger than the beam cross-section of the light beam on a second longitudinal optical sensor, wherein the second longitudinal optical sensor is located behind the first longitudinal optical sensor, the evaluation device may determine that the light beam is still narrowing and that the location of the first longitudinal optical sensor is situated before the focal point of the light beam. Contrarily, in case the beam cross-section of the light beam on the first longitudinal optical sensor is smaller than the beam cross-section of the light beam on the second longitudinal optical sensor, the evaluation device may determine that the light beam is widening and that the location of the second longitudinal optical sensor is situated behind the focal point. Thus, generally, the evaluation device may be adapted to recognize whether the light beam widens or narrows, by comparing the longitudinal sensor signals of different longitudinal sensors. Moreover, this recognition may work separately for each selected color by engaging, for each selected color, a group comprising a longitudinal optical sensor and at least one secondary longitudinal optical sensor exhibiting the same or a similar spectral sensitivity, which, particularly, shows high amplitudes at and/or around the selected color.

For further details with regard to determining the at least one item of information on the longitudinal position of the object by employing the evaluation device according to the present invention, reference may made to the description in WO 2014/097181 A1. Thus, generally, the evaluation device may be adapted to compare the beam cross-section and/or the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam.

In addition to the at least one longitudinal coordinate of the object, at least one transversal coordinate of the object may be determined. Thus, generally, the evaluation device may further be adapted to determine at least one transversal coordinate of the object by determining a position of the light beam on the at least one transversal optical sensor, which may be a pixelated, a segmented or a large-area transversal optical sensor, as further outlined also in WO 2014/097181 A1.

In a further aspect of the present invention, an arrangement comprising at least two detectors according to any of the preceding embodiments is proposed. Herein, the at least two detectors preferably may have identical optical properties but might also be different with respect from each other. In addition, the arrangement may further comprise at least one illumination source. Herein, the at least one object might be illuminated by using at least one illumination source which generates primary light, wherein the at least one object elastically or inelastically reflects the primary light, thereby generating a plurality of light beams which propagate to one of the at least two detectors. The at least one illumination source may form or may not form a constituent part of each of the at least two detectors. By way of example, the at least one illumination source itself may be or may comprise an ambient light source and/or may be or may comprise an artificial illumination source. This embodiment is preferably suited for an application in which at least two detectors, preferentially two identical detectors, are employed for acquiring depth information, in particular, for the purpose to providing a measurement volume which extends the inherent measurement volume of a single detector.

In a further aspect of the present invention, a human-machine interface for exchanging at least one item of information between a user and a machine is proposed. The human-machine interface as proposed may make use of the fact that the above-mentioned detector in one or more of the embodiments mentioned above or as mentioned in further detail below may be used by one or more users for providing information and/or commands to a machine. Thus, preferably, the human-machine interface may be used for inputting control commands.

The human-machine interface comprises at least one detector according to the present invention, such as according to one or more of the embodiments disclosed above and/or according to one or more of the embodiments as disclosed in further detail below, wherein the human-machine interface is designed to generate at least one item of geometrical information and/or color information of the user by means of the detector wherein the human-machine interface is designed to assign the geometrical information and/or the color information to at least one item of information, in particular to at least one control command.

In a further aspect of the present invention, an entertainment device for carrying out at least one entertainment function is disclosed. As used herein, an entertainment device is a device which may serve the purpose of leisure and/or entertainment of one or more users, in the following also referred to as one or more players. As an example, the entertainment device may serve the purpose of gaming, preferably computer gaming. Additionally or alternatively, the entertainment device may also be used for other purposes, such as for exercising, sports, physical therapy or motion tracking in general. Thus, the entertainment device may be implemented into a computer, a computer network or a computer system or may comprise a computer, a computer network or a computer system which runs one or more gaming software programs.

The entertainment device comprises at least one human-machine interface according to the present invention, such as according to one or more of the embodiments disclosed above and/or according to one or more of the embodiments disclosed below. The entertainment device is designed to enable at least one item of information to be input by a player by means of the human-machine interface. The at least one item of information may be transmitted to and/or may be used by a controller and/or a computer of the entertainment device.

In a further aspect of the present invention, a tracking system for tracking the position of at least one movable object is provided. As used herein, a tracking system is a device which is adapted to gather information on a series of past positions of the at least one object or at least one part of an object. Additionally, the tracking system may be adapted to provide information on at least one predicted future position of the at least one object or the at least one part of the object. The tracking system may have at least one track controller, which may fully or partially be embodied as an electronic device, preferably as at least one data processing device, more preferably as at least one computer or microcontroller. Again, the at least one track controller may comprise the at least one evaluation device and/or may be part of the at least one evaluation device and/or might fully or partially be identical to the at least one evaluation device.

The tracking system comprises at least one detector according to the present invention, such as at least one detector as disclosed in one or more of the embodiments listed above and/or as disclosed in one or more of the embodiments below. The tracking system further comprises at least one track controller. The tracking system may comprise one, two or more detectors, particularly two or more identical detectors, which allow for a reliable acquisition of depth information about the at least one object in an overlapping volume between the two or more detectors. The track controller is adapted to track a series of positions of the object, each position comprising at least one item of information on a position of the object at a specific point in time and at least one item of information on a color of the object at a specific point in time.

The tracking system may further comprise at least one beacon device connectable to the object. For a potential definition of the beacon device, reference may be made to WO 2014/097181 A1. The tracking system preferably is adapted such that the detector may generate an information on the position and/or the color of the object of the at least one beacon device, in particular to generate the information on the position of the object which comprises a specific beacon device exhibiting a specific spectral sensitivity. Thus, more than one beacon exhibiting a different color may be tracked by the detector of the present invention, preferably in a simultaneous manner. Herein, the beacon device may fully or partially be embodied as an active beacon device and/or as a passive beacon device. As an example, the beacon device may comprise at least one illumination source adapted to generate at least one light beam to be transmitted to the detector. Additionally or alternatively, the beacon device may comprise at least one reflector adapted to reflect light generated by an illumination source, thereby generating a reflected light beam to be transmitted to the detector.

In a further aspect of the present invention, a camera for imaging at least one object is disclosed. The camera comprises at least one detector according to the present invention, such as disclosed in one or more of the embodiments given above or given in further detail below. Thus, specifically, the present application may be applied in the field of color photography. Thus, the detector may be part of a photographic device, specifically of a digital camera. Specifically, the detector may be used for 3D photography, specifically for digital 3D photography. Thus, the detector may form a digital 3D camera or may be part of a digital 3D camera. As used herein, the term “photography” generally refers to the technology of acquiring image information of at least one object which may not only comprise geometrical information but also color information. As further used herein, a “camera” generally is a device adapted for performing photography. As further used herein, the term “digital photography” generally refers to the technology of acquiring image information of at least one object by using a plurality of light-sensitive elements adapted to generate electrical signals indicating an intensity and/or color of illumination, preferably digital electrical signals. As further used herein, the term “3D photography” generally refers to the technology of acquiring image information of at least one object in three spatial dimensions. Accordingly, a 3D camera is a device adapted for performing 3D photography. The camera generally may be adapted for acquiring a single image, such as a single 3D image, or may be adapted for acquiring a plurality of images, such as a sequence of images. Thus, the camera may also be a video camera adapted for video applications, such as for acquiring digital video sequences.

Thus, generally, the present invention further refers to a camera, specifically a digital camera, more specifically a 3D camera or digital 3D camera, for imaging at least one object. As outlined above, the term imaging, as used herein, generally refers to acquiring image information of at least one object. The camera comprises at least one detector according to the present invention. The camera, as outlined above, may be adapted for acquiring a single image or for acquiring a plurality of images, such as image sequence, preferably for acquiring digital video sequences. Thus, as an example, the camera may be or may comprise a video camera. In the latter case, the camera preferably comprises a data memory for storing the image sequence.

In a further aspect of the present invention, a method for determining a position of at least one object is disclosed. The method preferably may make use of at least one detector according to the present invention, such as of at least one detector according to one or more of the embodiments disclosed above or disclosed in further detail below. Thus, for optional embodiments of the method, reference might be made to the description of the various embodiments of the detector.

The method comprises the following steps, which may be performed in the given order or in a different order. Further, additional method steps might be provided which are not listed. Further, two or more or even all of the method steps might be performed simultaneously, at least partially. Further, two or more or even all of the method steps might be performed twice or even more than twice, repeatedly.

In a first method step, at least one transfer device of the detector is used. For this purpose, the transfer device comprises at least two different focal lengths in response to at least one incident light beam. Herein, one or more of the transfer devices as described above and/or below may be employed.

In a further method step, at least two longitudinal optical sensors of the detector are used. Accordingly, each longitudinal optical sensor has at least one sensor region which generates at least one longitudinal sensor signal in a manner dependent on an illumination of the sensor region by the light beam. Herein, the longitudinal sensor signal, given the same total power of the illumination, is dependent on a beam cross-section of the light beam in the sensor region. Further, each longitudinal optical sensor exhibits a spectral sensitivity in response to the light beam in a manner that two different longitudinal optical sensors differ with regard to their spectral sensitivity. Further, each longitudinal optical sensor is located at a focal point of the transfer device being related to the spectral sensitivity of the respective longitudinal optical sensor.

In a further method step, at least one evaluation device is used. For this purpose, the evaluation device generates at least one item of information on a longitudinal position and/or at least one item of information on a color of the object by evaluating the longitudinal sensor signal of each longitudinal optical sensor as described above and/or below.

In a further aspect of the present invention, a use of a detector according to the present invention is disclosed. Therein, a use of the detector for a purpose of determining, preferably in a simultaneous manner, a position, in particular a depth, and/or a color of an object is proposed, in particular, for a purpose of use selected from the group consisting of: a distance measurement, in particular in traffic technology; a position measurement, in particular in traffic technology; an entertainment application; a security application; a human-machine interface application; a tracking application; a photography application; an imaging application or camera application; a mapping application for generating maps of at least one space.

Preferably, for further potential details of the optical detector, the method, the human-machine interface, the entertainment device, the tracking system, the camera and the various uses of the detector, in particular with regard to the transfer device, the longitudinal optical sensors, the evaluation device and, if applicable, to the transversal optical sensor, the modulation device, the illumination source and the imaging device, specifically with respect to the potential materials, setups and further details, reference may be made to one or more of WO 2012/110924 A1, US 2012/206336 A1, WO 2014/097181 A1, and US 2014/291480 A1, the full content of all of which is herewith included by reference.

The above-described detector, the method, the human-machine interface and the entertainment device and also the proposed uses have considerable advantages over the prior art. Thus, generally, a simple and, still, efficient detector for an accurate determining a position and/or a color of at least one object in space may be provided. Therein, as an example, three-dimensional coordinates of a colored object or a part thereof may be determined in a fast and efficient way. Specifically, the application of at least two longitudinal optical sensors located at the respective focal points of a specifically accomplished transfer device, may lead to a compact, cost-efficient and, still, highly precise device which, allows determining different colors, preferably in a simultaneous manner.

As compared to devices known in the art, the detector as proposed provides a high degree of simplicity, specifically with regard to an optical setup of the detector. Thus, in principle, a simple combination of one, two or more sDSCs in combination with a suited transfer device, specifically a suited lens, and in conjunction with an appropriate evaluation device, is sufficient for high precision position and/or color detection. This high degree of simplicity, in combination with the possibility of high precision measurements, is specifically suited for machine control, such as in human-machine interfaces and, more preferably, in gaming. Thus, cost-efficient entertainment devices may be provided which may be used for a large number of gaming purposes.

Overall, in the context of the present invention, the following embodiments are regarded as particularly preferred:

### Embodiment 1

A detector for an optical detection of at least one object, comprising:
at least one transfer device, wherein the transfer device exhibits at least two different focal lengths in response to at least one incident light beam;
at least two longitudinal optical sensors, wherein each longitudinal optical sensor has at least one sensor region, wherein each longitudinal optical sensor is designed to generate at least one longitudinal sensor signal in a manner dependent on an illumination of the sensor region by the light beam, wherein the longitudinal sensor signal, given the same total power of the illumination, is dependent on a beam cross-section of the light beam in the sensor region, wherein each longitudinal optical sensor exhibits a spectral sensitivity in response to the light beam in a manner that two different longitudinal optical sensors differ with regard to their spectral sensitivity; wherein each longitudinal optical sensor is located at a focal point of the transfer device related to the spectral sensitivity of the respective longitudinal optical sensor; and
at least one evaluation device, wherein the evaluation device is designed to generate at least one item of information on a longitudinal position and/or at least one item of information on a color of the object by evaluating the longitudinal sensor signal of each longitudinal optical sensor.

### Embodiment 2

The detector according to the preceding embodiment, wherein the different focal lengths of the transfer device and the different spectral sensitivities of the at least two longitudinal optical sensors differ with respect to a wavelength of the at least one incident light beam.

### Embodiment 3

The detector according to the preceding embodiment, wherein the different focal lengths in the transfer device are created by a chromatic aberration caused by a material in the transfer device.

### Embodiment 4

The detector according to the preceding embodiment, wherein the transfer device comprises a refractive lens and/or a convex mirror.

### Embodiment 5

The detector according to any one of the preceding embodiments, wherein the different focal lengths in the transfer device are created by different areas within the transfer device, wherein each area comprises a focal length in a manner that two different areas differ with regard to their focal length.

### Embodiment 6

The detector according to the preceding embodiment, wherein the transfer device comprises a multifocal lens.

### Embodiment 7

The detector according to any one of the two preceding embodiments, wherein the transfer device further comprises transition regions between adjoining areas, wherein in each transition region the focal length varies between the focal lengths of the adjoining areas.

### Embodiment 8

The detector according to the preceding embodiment, wherein the transfer device comprises a progressive lens.

### Embodiment 9

The detector according to any of the preceding embodiments, wherein the at least one longitudinal optical sensor is a transparent optical sensor.

### Embodiment 10

The detector according to any of the preceding embodiments, wherein the sensor region of the longitudinal optical sensor is exactly one continuous sensor region, wherein the longitudinal sensor signal is a uniform sensor signal for the entire sensor region.

### Embodiment 11

The detector according to any of the preceding embodiments, wherein the sensor region of the longitudinal optical sensor is or comprises a sensor area, the sensor area being formed by a surface of the respective device, wherein the surface faces towards the object or faces away from the object.

### Embodiment 12

The detector according to any of the preceding embodiments, wherein the longitudinal sensor signal is selected from the group consisting of a current and a voltage.

### Embodiment 13

The detector according to any of the preceding embodiments, wherein the longitudinal optical sensor comprises at least one semiconductor detector, in particular an organic semiconductor detector comprising at least one organic material, preferably an organic solar cell and particularly preferably a dye solar cell or dye-sensitized solar cell, in particular a solid dye solar cell or a solid dye-sensitized solar cell.

### Embodiment 14

The detector according to the preceding embodiment, wherein the longitudinal optical sensor comprises at least one first electrode, at least one n-semiconducting metal oxide, at least one dye, at least one p-semiconducting organic material, preferably a solid p-semiconducting organic material, and at least one second electrode.

### Embodiment 15

The detector according to the preceding embodiment, wherein both the first electrode and the second electrode are transparent.

### Embodiment 16

The detector according to any of the preceding embodiments, wherein the evaluation device is designed to generate the at least one item of information on the longitudinal position of the object from at least one predefined relationship between the geometry of the illumination and a relative positioning of the object with respect to the detector, preferably taking account of a known power of the illumination and optionally taking account of a modulation frequency with which the illumination is modulated.

### Embodiment 17

The detector according to any of the preceding embodiments, wherein the detector furthermore has at least one modulation device for modulating the illumination.

### Embodiment 18

The detector according to the preceding embodiment, wherein the detector is designed to detect at least two longitudinal sensor signals in the case of different modulations, in particular at least two sensor signals at respectively different modulation frequencies, wherein the evaluation device is designed to generate the at least one item of information on the longitudinal position of the object by evaluating the at least two longitudinal sensor signals.

### Embodiment 19

The detector according to any of the preceding embodiments, wherein the longitudinal optical sensor is furthermore designed in such a way that the longitudinal sensor signal, given the same total power of the illumination, is dependent on a modulation frequency of a modulation of the illumination.

### Embodiment 20

The detector according to any one of the preceding embodiments, wherein the evaluation device is adapted to determine the at least one item of information on the color of the object by comparing the longitudinal sensor signals of the at least two longitudinal optical sensors.

### Embodiment 21

The detector according to the preceding embodiment, wherein the evaluation device is adapted to generate at least two color coordinates, wherein each color coordinate is determined by dividing the longitudinal sensor signal of one of the at least two longitudinal optical sensors by a normalization value, wherein the normalization value preferably comprises a sum of the longitudinal sensor signals of the at least two longitudinal optical sensors.

### Embodiment 22

The detector according to any one of the preceding embodiments, furthermore comprising at least one illumination source.

### Embodiment 23

The detector according to the preceding embodiment, wherein the illumination source is selected from: an illumination source, which is at least partly connected to the object and/or is at least partly identical to the object; an illumination source which is designed to at least partly illuminate the object with a primary radiation, wherein the light beam preferably is generated by a reflection of the primary radiation on the object and/or by light emission by the object itself, stimulated by the primary radiation.

### Embodiment 24

The detector according to the preceding embodiment, wherein the illumination source exhibits a spectral range which is related to the spectral sensitivities of the at least two longitudinal sensors.

### Embodiment 25

The detector according to the preceding embodiment, wherein the spectral sensitivities of the at least two longitudinal sensor are covered by the spectral range of the illumination source.

### Embodiment 26

The detector according to any of the preceding embodiments, wherein the detector has at least three longitudinal optical sensors, wherein the longitudinal optical sensors are stacked.

### Embodiment 27

The detector according to the preceding embodiment, wherein the longitudinal optical sensors are stacked along the optical axis.

### Embodiment 28

The detector according to any of the two preceding embodiments, wherein the longitudinal optical sensors form a longitudinal optical sensor stack, wherein the sensor regions of the longitudinal optical sensors are oriented perpendicular to the optical axis.

### Embodiment 29

The detector according to any of the three preceding embodiments, wherein the longitudinal optical sensors are arranged such that a light beam from the object illuminates all longitudinal optical sensors, preferably sequentially, wherein at least one longitudinal sensor signal is generated by each longitudinal optical sensor.

### Embodiment 30

The detector according to any of the four preceding embodiments, wherein at least two of the longitudinal optical sensors exhibit different spectral sensitivities.

### Embodiment 31

The detector according to the preceding embodiment, wherein the different spectral sensitivities are arranged over a spectral range allowing each of the at least two of the longitudinal optical sensors to be sensitive to a specific color.

### Embodiment 32

The detector according to the preceding embodiment, wherein the longitudinal optical sensors comprise at least one first longitudinal optical sensor absorbing light in a first spectral range, wherein the longitudinal optical sensors further comprise at least one second longitudinal optical sensor absorbing light in a second spectral range being different from the first spectral range, wherein the longitudinal optical sensors further comprise at least one third longitudinal optical sensor absorbing light in a third spectral range which includes both the first spectral range and the second spectral range.

### Embodiment 33

The detector according to any of the two preceding embodiments, wherein the specific color comprises two, three or more of at least one red, green, blue, white, cyan, yellow, or magenta segment.

### Embodiment 34

The detector according to any of the preceding embodiments, wherein the longitudinal optical sensors differ by at least two different dyes.

### Embodiment 35

The detector according to any of the preceding embodiments, wherein the evaluation device is adapted to normalize the longitudinal sensor signals and to generate the information on the longitudinal position of the object independent from an intensity of the light beam.

### Embodiment 36

The detector according to any of the seven preceding embodiments, wherein the evaluation device is adapted to recognize whether the light beam widens or narrows, by comparing the longitudinal sensor signals of different longitudinal sensors.

### Embodiment 37

The detector according to any of the preceding embodiments, wherein the at least two transversal optical sensors use at least two transparent substrates.

### Embodiment 38

The detector according to the preceding embodiment, wherein the substrates differ from each other with regard to a geometrical quantity and/or to a material quantity related to the substrates.

### Embodiment 39

The detector according to the preceding embodiment, wherein the substrates differ from each other by the thickness.

### Embodiment 40

The detector according to any of the two preceding embodiments, wherein the substrates differ from each other by shape.

### Embodiment 41

The detector according to the preceding embodiment, wherein the shape is selected from the group comprising a planar, a planar-convex, a planar-concave, a biconvex, a biconcave or any other form employed for optical purposes.

### Embodiment 42

The detector according to any of the five preceding embodiments, wherein the substrates are rigid or flexible.

### Embodiment 43

The detector according to any of the six preceding embodiments, wherein the substrates are covered or coated.

### Embodiment 44

The detector according to any of the preceding embodiments, wherein the evaluation device is adapted to generate the at least one item of information on the longitudinal position of the object by determining a diameter of the light beam from the at least one longitudinal sensor signal.

### Embodiment 45

The detector according to the preceding embodiment, wherein the evaluation device is adapted to compare the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam.

### Embodiment 46

The detector according to any one of the preceding embodiment, further comprising at least two secondary longitudinal optical sensors, wherein each secondary longitudinal optical sensor has at least one sensor region, wherein each secondary longitudinal optical sensor is designed to generate at least one longitudinal sensor signal in a manner dependent on an illumination of the sensor region by the light beam, wherein the longitudinal sensor signal, given the same total power of the illumination, is dependent on a beam cross-section of the light beam in the sensor region, wherein each secondary longitudinal optical sensor exhibits a spectral sensitivity in response to the light beam in a manner that two secondary longitudinal optical sensors differ with regard to their spectral sensitivity, wherein the evaluation device is further designed to generate at least one item of information on a longitudinal position of the object by evaluating the longitudinal sensor signal of each secondary longitudinal optical sensor.

### Embodiment 47

The detector according to the preceding embodiment, wherein each secondary longitudinal optical sensor comprises the same spectral sensitivity as one of the longitudinal optical sensors.

### Embodiment 48

The detector according to any one of the two preceding embodiments, wherein the secondary longitudinal optical sensors which comprise a different spectral sensitivity are arranged as at least one secondary stack.

### Embodiment 49

The detector according to the preceding embodiment, wherein the stack of longitudinal optical sensors is framed by two separate secondary stacks along the optical axis of the detector.

### Embodiment 50

The detector according to any one of the four preceding embodiments, wherein the evaluation device is adapted to compare the longitudinal sensor signal of at least one of the longitudinal optical sensors with the longitudinal sensor signal of at least one of the secondary longitudinal optical sensors in order to determine the at least one item of information on the longitudinal position of the object.

### Embodiment 51

The detector according to the preceding embodiment, wherein the evaluation device is adapted to compare the longitudinal sensor signal of a selected longitudinal optical sensor with the longitudinal sensor signal of the at least one secondary longitudinal optical sensor which comprises the same spectral sensitivity as the selected longitudinal optical sensor.

### Embodiment 52

The detector according to any one of the preceding embodiments, further comprising at least one transversal optical sensor, the transversal optical sensor being adapted to determine a transversal position of the light beam traveling from the object to the detector, the transversal position being a position in at least one dimension perpendicular to an optical axis of the detector, the transversal optical sensor being adapted to generate at least one transversal sensor signal, wherein the evaluation device is further designed to generate at least one item of information on a transversal position of the object by evaluating the transversal sensor signal.

### Embodiment 53

The detector according to the preceding embodiment, wherein the transversal optical sensor comprises at least one first electrode, at least one n-semiconducting metal oxide, at least one dye, at least one photovoltaic material, and at least one second electrode.

### Embodiment 54

The detector according to any of the two preceding embodiments, wherein the photovoltaic material comprises at least one organic photovoltaic material and wherein the transversal optical sensor is an organic photo detector.

### Embodiment 55

The detector according to any of the three preceding embodiments, wherein the organic photo detector is a dye-sensitized solar cell.

### Embodiment 56

The detector according to the preceding embodiment, wherein the dye-sensitized solar cell is a solid dye-sensitized solar cell, comprising a layer setup embedded in between the first electrode and the second electrode, the layer setup comprising at least one n-semiconducting metal oxide, at least one dye, and at least one solid p-semiconducting organic material.

### Embodiment 57

The detector according to any of the eight preceding embodiments, wherein the first electrode at least partially is made of at least one transparent conductive oxide, wherein the second electrode at least partially is made of an electrically conductive polymer, preferably a transparent electrically conductive polymer.

### Embodiment 58

The detector according to the preceding embodiment, wherein the conductive polymer is selected from the group consisting of: a poly-3,4-ethylenedioxythiophene (PEDOT), preferably PEDOT being electrically doped with at least one counter ion, more preferably PEDOT doped with sodium polystyrene sulfonate (PEDOT:PSS); a polyaniline (PANI); a polythiophene.

### Embodiment 59

The detector according to any of the two preceding embodiments, wherein the conductive polymer provides an electric resistivity of 0.1-20 kΩ between the partial electrodes, preferably an electric resistivity of 0.5-5.0 kΩ and, more preferably, an electric resistivity of 1.0-3.0 kΩ.

### Embodiment 60

The detector according to any of the seven preceding embodiments, wherein the sensor region of the transversal optical sensor is or comprises a sensor area, the sensor area being formed by a surface of the respective device, wherein the surface faces towards the object or faces away from the object.

### Embodiment 61

The detector according to any of the eight preceding embodiments, wherein the first electrode and/or the second electrode are a split electrode comprising at least two partial electrodes.

### Embodiment 62

The detector according to the preceding embodiments, wherein at least four partial electrodes are provided.

### Embodiment 63

The detector according to any one of the two preceding embodiments, wherein electrical currents through the partial electrodes are dependent on a position of the light beam in the sensor region.

### Embodiment 64

The detector according to the preceding embodiment, wherein the transversal optical sensor is adapted to generate the transversal sensor signal in accordance with the electrical currents through the partial electrodes.

### Embodiment 65

The detector according to any of the two preceding embodiments, wherein the detector, preferably the transversal optical sensor and/or the evaluation device, is adapted to derive the information on the transversal position of the object from at least one ratio of the currents through the partial electrodes.

### Embodiment 66

The detector according to any of the fourteen preceding embodiments, wherein the at least one transversal optical sensor is a transparent optical sensor.

### Embodiment 67

The detector according to any of the fifteen preceding embodiments, wherein the transversal optical sensor and the longitudinal optical sensor are stacked along the optical axis such that a light beam travelling along the optical axis both impinges the transversal optical sensor and the at least two longitudinal optical sensors.

### Embodiment 68

The detector according to the preceding embodiment, wherein the light beam subsequently passes through the transversal optical sensor and the at least two longitudinal optical sensors or vice versa.

### Embodiment 69

The detector according to the preceding embodiment, wherein the light beam passes through the transversal optical sensor before impinging on one of the longitudinal optical sensors.

### Embodiment 70

The detector according to any of the seventeen preceding embodiments, wherein the transversal optical sensor and one of the longitudinal optical sensors are identical.

### Embodiment 71

The detector according to any of the eighteen preceding embodiments, wherein the transversal sensor signal is selected from the group consisting of a current and a voltage or any signal derived thereof.

### Embodiment 72

The detector according to any one of the preceding embodiments, wherein the detector further comprises at least one imaging device.

### Embodiment 73

The detector according to the preceding claim, wherein the imaging device is located in a position furthest away from the object.

### Embodiment 74

The detector according to any of the two preceding embodiments, wherein the light beam passes through the at least one longitudinal optical sensor before illuminating the imaging device.

### Embodiment 75

The detector according to any of the three preceding embodiments, wherein the imaging device comprises a camera.

### Embodiment 76

The detector according to any of the four preceding embodiments, wherein the imaging device comprises at least one of: an inorganic camera; a monochrome camera; a multichrome camera; a full-color camera; a pixelated inorganic chip; a pixelated organic camera; a CCD chip, preferably a multi-color CCD chip or a full-color CCD chip; a CMOS chip; an IR camera; an RGB camera.

### Embodiment 77

An arrangement comprising at least two detectors according to any of the preceding embodiments.

### Embodiment 78

An arrangement according to the preceding embodiment, wherein the at least two detectors have identical optical properties.

### Embodiment 79

The arrangement according to any of the two preceding embodiments, wherein the arrangement further comprises at least one illumination source.

### Embodiment 80

A human-machine interface for exchanging at least one item of information between a user and a machine, in particular for inputting control commands, wherein the human-machine interface comprises at least one detector according to any of the preceding embodiments relating to a detector, wherein the human-machine interface is designed to generate at least one item of geometrical information and/or color of the user by means of the detector wherein the human-machine interface is designed to assign to the geometrical information at least one item of information, in particular at least one control command.

### Embodiment 81

The human-machine interface according to the preceding embodiment, wherein the at least one item of geometrical information of the user is selected from the group consisting of: a position of a body of the user; a position of at least one body part of the user; an orientation of a body of the user; an orientation of at least one body part of the user.

### Embodiment 82

The human-machine interface according to any of the two preceding embodiments, wherein the human-machine interface further comprises at least one beacon device connectable to the user, wherein the human-machine interface is adapted such that the detector may generate an information on the position of the at least one beacon device.

### Embodiment 83

The human-machine interface according to the preceding embodiment, wherein the beacon device comprises at least one illumination source adapted to generate at least one light beam to be transmitted to the detector.

### Embodiment 84

An entertainment device for carrying out at least one entertainment function, in particular a game, wherein the entertainment device comprises at least one human-machine interface according to any of the preceding embodiments referring to a human-machine interface, wherein the entertainment device is designed to enable at least one item of information to be input by a player by means of the human-machine interface, wherein the entertainment device is designed to vary the entertainment function in accordance with the information.

### Embodiment 85

A tracking system for tracking the position of at least one movable object, the tracking system comprising at least one detector according to any of the preceding embodiments referring to a detector, the tracking system further comprising at least one track controller, wherein the track controller is adapted to track a series of positions and/or colors of the object, each comprising at least one item of information on a position of the object at a specific point in time and/or at least one item of information on a color of the object at a specific point in time.

### Embodiment 86

The tracking system according to the preceding embodiment, wherein the tracking system further comprises at least one beacon device connectable to the object, wherein the tracking system is adapted such that the detector may generate an information on the position of the object of the at least one beacon device.

### Embodiment 87

A camera for imaging at least one object, the camera comprising at least one detector according to any one of the preceding embodiments referring to a detector.

### Embodiment 88

A method for an optical detection of at least one object, in particular using a detector according to any of the preceding embodiments relating to a detector,
wherein at least one transfer device of a detector is used, wherein the transfer device comprises at least two different focal lengths in response to at least one incident light beam;
wherein at least two longitudinal optical sensors of the detector are used, wherein each longitudinal optical sensor has at least one sensor region, wherein each longitudinal optical sensor generates at least one longitudinal sensor signal in a manner dependent on an illumination of the sensor region by the light beam, wherein the longitudinal sensor signal, given the same total power of the illumination, is dependent on a beam cross-section of the light beam in the sensor region, wherein each longitudinal optical sensor exhibits a spectral sensitivity in response to light beam in a manner that two different longitudinal optical sensors differ with regard to their spectral sensitivity; wherein each longitudinal optical sensor is located at a focal point of the transfer device related to the spectral sensitivity of the respective longitudinal optical sensor;
wherein at least one evaluation device is used, wherein the evaluation device generates at least one item of information on a longitudinal position and/or at least one item of information on a color of the object by evaluating the longitudinal sensor signal of each longitudinal optical sensor.

### Embodiment 89

The use of a detector according to any of the preceding embodiments relating to a detector for a purpose of, preferably simultaneously, determining a position, in particular a depth, and/or a color of an object.

### Embodiment 90

The use of a detector according to the previous embodiment, for a purpose of use, selected from the group consisting of: a distance measurement, in particular in traffic technology; a position measurement, in particular in traffic technology; an entertainment application; a security application; a human-machine interface application; a tracking application; a photography application; an imaging application or camera application; a mapping application for generating maps of at least one space.

### BRIEF DESCRIPTION OF THE FIGURES

Further optional details and features of the invention are evident from the description of preferred exemplary embodiments which follows in conjunction with the dependent claims. In this context, the particular features may be implemented alone or with features in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an exemplary embodiment of a detector according to the present invention which comprises a stack of longitudinal optical sensors and a secondary stack of secondary longitudinal optical sensors;

FIG. 2 shows a further exemplary embodiment of a detector according to the present invention comprising a stack of longitudinal optical sensors along the optical axis which is framed by two separate secondary stacks of secondary longitudinal optical sensors;

FIG. 3 shows an exemplary explanation of the occurrence of the FiP effect within the embodiment of FIG. 2.

FIG. 4 shows an exemplary embodiment of an optical detector, a detector system, a human-machine interface, an entertainment device, a tracking system and a camera according to the present invention.

### EXEMPLARY EMBODIMENTS

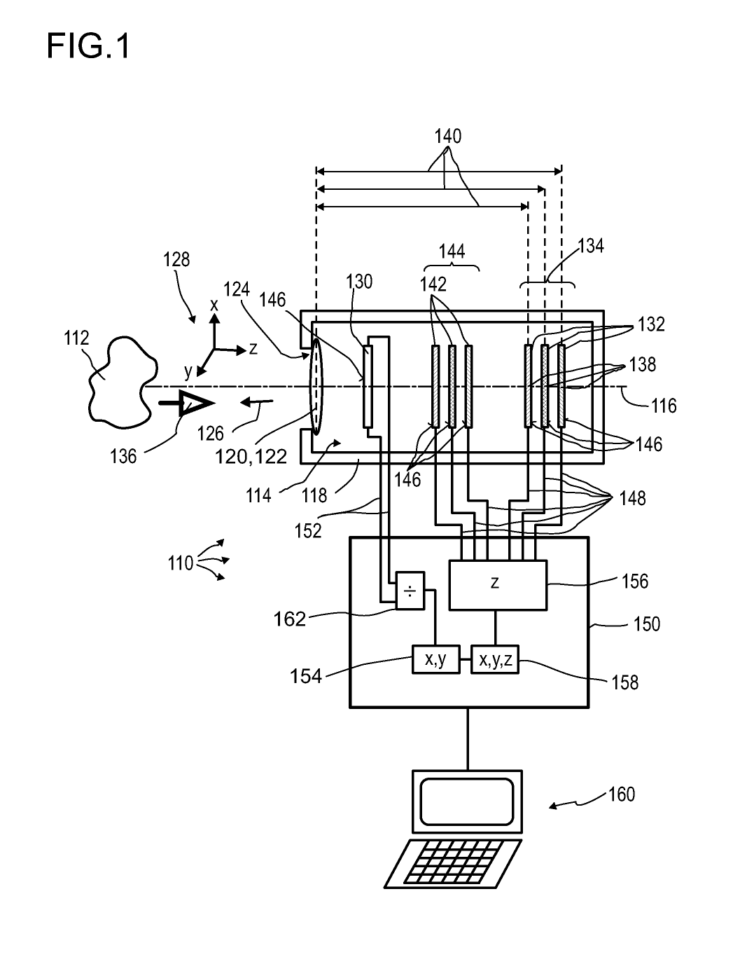

FIG. 1 illustrates, in a highly schematic illustration, an exemplary embodiment of a detector 110 according to the present invention, for determining a position of at least one object 112. The detector 110 preferably may form a camera or may be part of a camera. However, other embodiments are feasible.

The detector 110 comprises optical sensors 114, which, in this particular embodiment, are all stacked along an optical axis 116 of the detector 110. Specifically, the optical axis 116 may be an axis of symmetry and/or rotation of the setup of the optical sensors 114. The optical sensors 114 may be located inside a housing 118 of the detector 110. Further, at least one transfer device 120 is comprised, preferably a refractive lens 122. An opening 124 in the housing 118, which, preferably, is located concentrically with regard to the optical axis 116, preferably defines a direction of view 126 of the detector 110. A coordinate system 128 may be defined, in which a direction parallel or antiparallel to the optical axis 116 is defined as a longitudinal direction, whereas directions perpendicular to the optical axis 116 may be defined as transversal directions. In the coordinate system 128, symbolically depicted in FIG. 1, a longitudinal direction is denoted by z and transversal directions are denoted by x and y, respectively. However, other types of coordinate systems 128 are feasible.

In this particular embodiment, the optical sensors 114 comprise a transversal optical sensor 130 and a plurality of longitudinal optical sensors 132, wherein the longitudinal optical sensors 132 form a stack 134 of longitudinal optical sensors. In the embodiment shown in FIG. 1, three longitudinal sensors 132 are depicted. It shall be noted, however, that embodiments having a different number of longitudinal optical sensors 132, such as two, four, five, six or more longitudinal optical sensors 132, are feasible, particularly depending on the respective purposes of the detector 110. The transversal optical sensor 130 may be embodied as a separate optical sensor 114, as depicted in FIG. 1, but may also be combined with one of the longitudinal optical sensors 132 into a combined optical sensor (not depicted here).

According to the present invention, each longitudinal optical sensor 132 within the stack 134 of longitudinal optical sensors 132 exhibits a spectral sensitivity in response to a light beam 136 in a manner that the different longitudinal optical sensors 132 within the stack 134 differ with respect to their respective spectral sensitivity. Hereby, the different spectral sensitivity of the longitudinal optical sensors 132 within the stack 134 is indicated by a different hatching of the respective shapes. By way of example, the three longitudinal optical sensors 132 as depicted in FIG. 1 may have different spectral sensitivities with maximum absorption wavelengths in a spectral range between 600 nm and 780 nm (red), between 490 nm and 600 nm (green), and between 380 nm and 490 nm (blue), respectively. However, other color distributions, such as cyan, magenta, and yellow, are possible. Hereby, the different spectral sensitivities may be achieved by using different dyes within the longitudinal optical sensors 132.

Further according to the present invention, each longitudinal optical sensor 132 within the stack 134 of longitudinal optical sensors 132 is located at a focal point 138 of the transfer device 120, wherein here each of the focal points 138 is related to the spectral sensitivity of the respective longitudinal optical sensor. For this purpose, the refractive lens 122, which here constitutes the transfer device 120, may exhibit at least three different focal lengths 140 in response to at least one incident light beam 136. In this particular embodiment, the refractive lens 122 may, preferably, be considered as a thin lens in air so that the corresponding focal length 140 may be determined as a distance from a center of the refractive lens 122 to the focal points 140 of the refractive lens 122. For a converging lens, such as for a convex lens as employed here for the refractive lens 122, the focal length 140 may be defined as a positive value of the distance in which the beam 136 of a collimated light of at least one color might be focused to a single spot which is usually denote as the focus or the focal point 138. By way of the example, the longitudinal optical sensor 132 which may have a spectral sensitivity with a maximum absorption wavelength in the red spectral range, may, therefore, be located at the focal point 138 of the refractive lens 122 for a red incident light beam 136, whereas the longitudinal optical sensor 132 which may have a spectral sensitivity with a maximum absorption wavelength in the green or blue spectral range, may, thus, be located at the focal points 138 of the refractive lens 122 for a green or blue incident light beam 136, respectively. Again, in case other color distributions, such as cyan, magenta, and yellow, might be used, the locations of the longitudinal optical sensors 132 may be adapted accordingly.

In this particular embodiment, the optical sensors 114 further comprise a plurality of secondary longitudinal optical sensors 142, wherein the longitudinal optical sensors 132 form a secondary stack 144 of longitudinal optical sensors. In the embodiment as illustrated in FIG. 1, three secondary longitudinal sensors 142 are depicted. It shall be noted, however, that embodiments having a different number of secondary longitudinal optical sensors 142, such as two, four, five, six or more secondary longitudinal optical sensors 142, are feasible, particularly depending on the respective purposes of the detector. With regard to the present invention, the secondary longitudinal optical sensors 142 may exhibit the same or a similar setup and comprise the same or similar physical and optical properties as the longitudinal optical sensors 132 with the notable exception that the secondary longitudinal optical sensors 142 are not located at the respective focal points 138 of the transfer device 120, in particular, since these locations have already been occupied by the longitudinal optical sensors 132. Rather, the secondary stack 144 is located in a manner that it is impinged by the incident light beam 136 before (as depicted in FIG. 1) or after (not depicted here) the stack 134 of the longitudinal optical sensors 132 is illuminated.

Further, each secondary longitudinal optical sensor 142 within the secondary stack 144 of secondary longitudinal optical sensors 142 exhibits a spectral sensitivity in response to a light beam 136 in a manner that two secondary longitudinal optical sensors 142 differ with regard to their spectral sensitivity. In the particular embodiment as depicted in FIG. 1, each of the three secondary longitudinal optical sensors 142 comprises the same spectral sensitivity as one of the three longitudinal optical sensors 132. Hereby, the same spectral sensitivity of each of the secondary longitudinal optical sensors 142 with one of the three longitudinal optical sensors 132 is indicated by the same hatching of the respective shapes of the corresponding optical sensors.

Summarizing, in the specific example as shown in FIG. 1, the detector 110 comprises seven optical sensors 114, i.e. the transversal optical sensor 130, the three longitudinal optical sensors 132 arranged in the stack 134, and the three secondary longitudinal optical sensors 142 arranged in the secondary stack 144, wherein both the stack 134 and the secondary stack 144 exhibit the same number of optical sensors 114 and comprise the same selection of different types of optical sensors with regard to their spectral sensitivities, such as a red-sensitive optical sensor, a green-sensitive optical sensor, and a blue-sensitive optical sensor. However, other colors might be possible. Herein, preferably, the transversal optical sensor 130, all of the longitudinal optical sensors 132 and all of the secondary longitudinal optical sensors 142 may be transparent.

Each of the longitudinal optical sensors 132 as well as each of the secondary longitudinal optical sensors 142 comprises a sensor region 146, which, preferably, is transparent to the light beam 138 travelling from the object 112 to the detector 110. Consequently, each of the longitudinal optical sensors 132 is designed to generate at least one longitudinal sensor signal in a manner dependent on an illumination of the respective sensor region 146 by the light beam 136. In the same manner, each of the secondary longitudinal optical sensors 132 is designed to generate at least one longitudinal sensor signal in a manner dependent on an illumination of the respective sensor region 146 by the light beam 136. Thus, the longitudinal sensor signals, given the same total power of the illumination, is, according to the FiP effect, dependent on a beam cross-section of the light beam 136 in the respective sensor region 146, as will be outlined in further detail below. Via one or more longitudinal signal leads 148, the longitudinal sensor signals may be transmitted to an evaluation device 150, which will be explained in further detail below.

Also, the transversal optical sensor 130 comprises the sensor region 146, which, preferably, is transparent to the light beam 136 travelling from the object 112 to the detector 110. The transversal optical sensor 130 may, therefore, be adapted to determine a transversal position of the light beam 136 in one or more transversal directions, such as in direction x and/or in direction y. For this purpose, the at least one transversal optical sensor 130 may further be adapted to generate at least one transversal sensor signal. This transversal sensor signal may be transmitted by one or more transversal signal leads 152 to at least one evaluation device 150 of the detector 110.

Thus, the evaluation device 150 is, generally, designed to generate at least one item of information on a position and/or at least one item of information on a color of the object 112 by evaluating the sensor signals of one or more, preferably all, of the optical sensors 114. In this particular example, the evaluation device 150 is designed to generate at least one item of information on a longitudinal position of the object 112 and/or the color of the object 112 by evaluating the longitudinal sensor signal of one or both of each longitudinal optical sensor 132 and of each secondary longitudinal optical sensor 142. Further in this embodiment, the evaluation device 150 may be designed to generate at least one item of information on a transversal position of the object 112 by evaluating the transversal sensor signal of the longitudinal optical sensor 130. For these purposes, the evaluation device 150 may comprise one or more electronic devices and/or one or more software components, in order to evaluate the sensor signals, which are symbolically denoted by a transversal evaluation unit 154 (denoted by “xy”) and longitudinal evaluation unit 156 (denoted by “z”). By combining results derived by these evolution units 154, 156, a position information 158, preferably a three-dimensional position information, may be generated (denoted by “x, y, z”).

As will be explained below in more detail, the evaluation device 150 may be adapted to determine the at least one item of information on the longitudinal position of the object 112 by comparing the longitudinal sensor signal of the longitudinal optical sensors 132 with the longitudinal sensor signal of the secondary longitudinal optical sensors 142. For this purpose, the evaluation device 150 may, particularly, be adapted to compare the longitudinal sensor signal of a selected longitudinal optical sensor 132 with the longitudinal sensor signal of the secondary longitudinal optical sensor 142 which comprises the same spectral sensitivity as the selected longitudinal optical sensor 132.

Alternatively or in addition, the evaluation device 150 may be adapted to determine the at least one item of information on the color of the object 112 by comparing the longitudinal sensor signals of the longitudinal optical sensors 132. For this purpose, the spectral sensitivities of the longitudinal optical sensors may be considered as a coordinate system in color space, and the signals provided by the respective longitudinal optical sensors 132 may provide a coordinate in this color space, e.g. in CIE coordinates. Consequently, the evaluation device may be adapted to generate at least two color coordinates, preferably at least three color coordinates, wherein each of the color coordinates may be determined by dividing a longitudinal sensor signal of one of the spectrally sensitive optical sensors 132 by a normalization value, wherein the normalization value may comprise a sum of the signals of all spectrally sensitive longitudinal optical sensors 132. This task may equally be performed within the longitudinal evaluation unit 156 comprised within the evaluation device 150.

As already explained above, the detector in this particular example as depicted in FIG. 1 may comprise three longitudinal optical sensors 132 in the stack 134 of longitudinal optical sensors 132, wherein all of the longitudinal optical sensors 132 have different spectral sensitivities, such as with the maximum absorption wavelengths in the red, green, and blue spectral range. Consequently, the evaluation device 150 may be adapted to generate at least one item of color information by evaluating the respective intensities of the longitudinal sensor signals of the three longitudinal optical sensors 132 in the stack 134 and by determining therefrom the corresponding color coordinate in the color space designated by the respective spectral sensitivities of the three longitudinal optical sensors 132 in the stack 134 as previously described. Since, according to the present invention, the three longitudinal optical sensors 132 are all located at their respective focal point 138 with regard to their spectral sensitivity, they each provide high signal intensities of the corresponding longitudinal sensor signals, thus allowing determining the color of the object 112 with a high degree of accuracy.

Generally, the evaluation device 150 may be part of a data processing device 160 and/or may comprise one or more data processing devices 160. The evaluation device 150 may be fully or partially integrated into the housing 118 and/or may fully or partially be embodied as a separate device which is electrically connected in a wireless or wire-bound fashion to the optical sensors 114. The evaluation device 150 may further comprise one or more additional components, such as one or more electronic hardware components and/or one or more software components, such as one or more measurement units (not depicted in FIG. 1) and/or one or more transformation units 162. Symbolically, in FIG. 1, one optional transformation unit 162 is depicted which may be adapted to transform at least two transversal sensor signals acquired from the transversal optical sensor 130 into a common signal or common information.

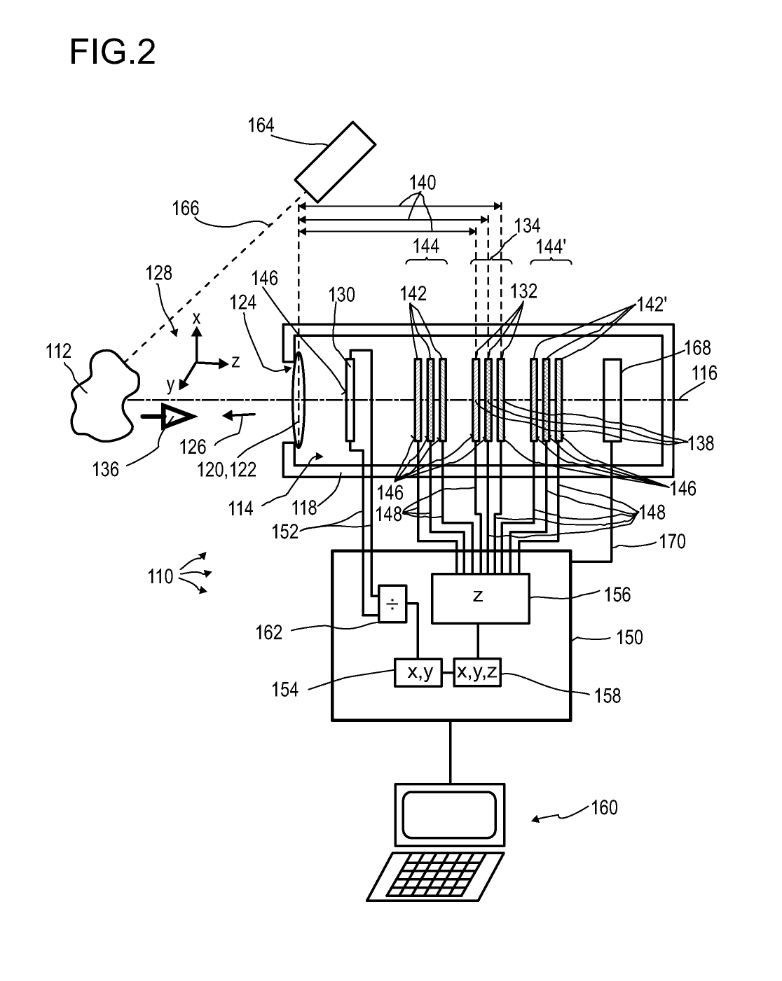

FIG. 2 illustrates, in a highly schematic illustration, a further exemplary embodiment of the detector 110 according to the present invention, for determining a position of the at least one object 112. In this particular embodiment, the detector 110 may comprise one or more illumination sources 164, which may include an ambient light source and/or an artificial light source, and/or may comprise one or more reflective elements which may, for example, be connected to the object 112 for reflecting one or more primary light beams 166, as indicated in FIG. 2. In addition or alternatively, the light beam 136 which emerges from the object 112 can fully or partially be generated by the object 112 itself, for example in the form of a luminescent radiation.

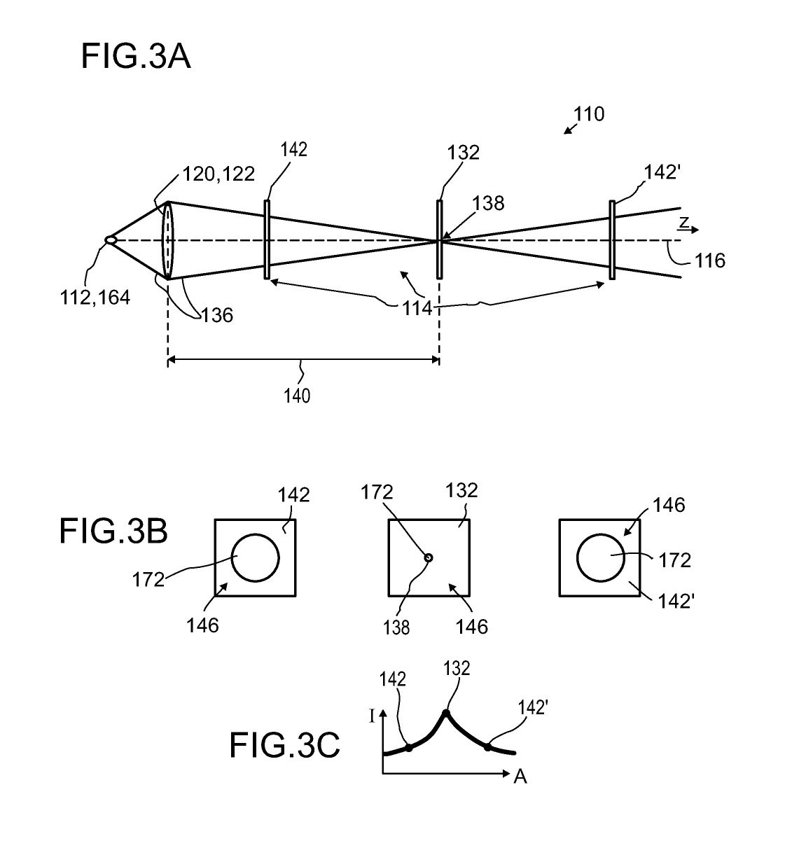

In the further example as shown in FIG. 2, the detector 110 comprises ten optical sensors 114, i.e. the one transversal optical sensor 130, the stack 134 with the three longitudinal optical sensors 132 which is framed by two secondary stacks 144, 144′, each comprising the three secondary longitudinal optical sensors 142, wherein both the stack 134 and the secondary stacks 144, 144′ are arranged along the optical axis 116, comprise the same number of optical sensors 114, and comprise the same selection of different types of optical sensors with regard to their spectral sensitivities, such as red-sensitive, green-sensitive, and blue-sensitive optical sensors. Again, the same spectral sensitivity of each of the secondary longitudinal optical sensors 142, 142′ within both secondary stacks 144, 144′ with one of the three longitudinal optical sensors 132 is indicated by the same hatching as used for the respective shapes. In this particular preferred example, the secondary stacks 144, 144′ are located in a manner that the first secondary stack 144 is impinged by the incident light beam 136 before the stack 134 of the longitudinal optical sensors 132 but the second secondary stack 144 is impinged by the incident light beam 136 after the stack 134 of the longitudinal optical sensors 132. The particular advantage of the further secondary longitudinal optical sensors 142 as arranged within the further secondary stack 144′ will be explained below with regard to FIG. 3.

Preferably, all of the longitudinal optical sensors 132 and the secondary longitudinal optical sensors 142, 142′ are transparent, in particular, to enabling a high relative intensity at each the optical sensors 114. In this particularly it may, therefore, be possible to further place a separate imaging device 168 as an additional optical sensor behind the three stacks 134, 144, 144′, such as in a manner that a light beam 136 first travels through the plurality of the optical sensors 114 within the three stacks 134, 144, 144′ until it impinges on the imaging device 168.

The imaging device 168 may be configured in various ways. Thus, the imaging device 168 can for example be part of the detector 110 within the detector housing 118. Alternatively, the imaging device 168 may be separately located outside the detector housing 118. The imaging device 168 may be fully or partially transparent or intransparent. The imaging device 168 may be or may comprise an organic imaging device or an inorganic imaging device. Preferably, the imaging device 168 may comprise at least one matrix of pixels, wherein the matrix of pixels is particularly selected from the group consisting of: an inorganic semiconductor sensor device such as a CCD chip and/or a CMOS chip; an organic semiconductor sensor device. The imaging device signal may be transmitted by one or more imaging device signal leads 170 to the evaluation device 150 of the detector 110.

With respect to the further features as presented in an exemplary fashion in FIG. 2, reference may be made to the above description of FIG. 1.

In FIGS. 3A to 3C, the occurrence of the above-mentioned FiP effect shall in the exemplary embodiment of FIG. 2 shall be explained. Herein, FIG. 3A shows a side-view of a part of the detector 110 in a plane parallel to the optical axis 116. Of the detector 110, only the transfer device 120, one of the longitudinal optical sensors 132 and two secondary longitudinal optical sensors 142, 142′ which belong to a different secondary stack 14, 144′ are depicted. Herein, both the selected longitudinal optical sensor 132 and the selected secondary longitudinal optical sensors 142, 142′ exhibit the same or a similar spectral sensitivity. Not shown here are the transversal optical sensor 130 as well as the other longitudinal optical sensors 132 and the other secondary longitudinal optical sensors 142, 142′, which comprise a different spectral sensitivity.

A measurement may start with an emission and/or reflection of one or more light beams 136 by the at least one object 112. The object 112 may comprise an illumination source 164, which may be considered as a part of the detector 110. Additionally or alternatively, a separate illumination source 164 may be used. Due to a characteristic of the light beam 136 itself and/or due to beam shaping characteristics of the transfer device 120, preferably the at least one refractive lens 122, the beam properties of the light beam 136 in the region of the longitudinal optical sensor 132 and of the secondary longitudinal optical sensors 142, 142′ at least partially are known. Thus, as depicted in FIG. 3A, the focal point 138 occurs in the distance which constitutes the focal length 140 of the refractive lens 122. In the focal point 138, where the selected longitudinal optical sensor 132 is located, a beam waist or a cross-section of the light beam 136 may assume a minimum value.

In FIG. 3B, in a top-view onto the sensor regions 146 of the longitudinal optical sensor 132 and of the secondary longitudinal optical sensors 142, 142′ in FIG. 3A, a development of light spots 172 generated by the light beam 136 impinging on the sensor regions 146 is depicted. As can be seen, close to the focal point 138, the cross-section of the light spot 172 assumes a minimum value.

In FIG. 3C, a photo current I of the longitudinal optical sensor 132 and of the secondary longitudinal optical sensors 142, 142′ is given for the three cross-sections of the light spot 172 as depicted in FIG. 3B, since both the longitudinal optical sensors 132 and the secondary longitudinal optical sensors 142, 142′ exhibit the FiP effect. Thus, as an exemplary embodiment, three different values for the photo currents I of the spot cross-sections as shown in FIG. 3B are shown for typical DSC devices, preferably sDSC devices. The photo current I is depicted here as a function of the area A of the light spot 172, which constitutes a measure of the cross-section of the light spots 172.

As can be seen from FIG. 3C, the photo current I, even if the selected longitudinal optical sensor 132 and secondary longitudinal optical sensors 142, 142′ are illuminated with the same total power of the illumination, the photo current I is dependent on the cross-section of the light beam 136, such as by providing a strong dependency on the cross-sectional area A and/or the beam waist of the light spot 172. Thus, the photo current is a function both of the power of the light beam 136 and of the cross-section of the light beam 136:

I=f(n,a).

Herein, I denotes the photo current provided by the selected longitudinal optical sensor 132 and secondary longitudinal optical sensors 142, 142′, such as a photo current measured in arbitrary units, as a voltage over at least one measurement resistor and/or in amps. n denotes the overall number of photons impinging on the sensor regions 146 and/or the overall power of the light beam in the sensor region 146. A denotes the beam cross-section of the light beam 136, provided in arbitrary units, as a beam waist, as a beam diameter of beam radius or as an area of the light spot 172. As an example, the beam cross-section may be calculated by the 1/e² diameter of the light spot 172, i.e. a cross-sectional distance from a first point on a first side of a maximum intensity having an intensity of 1/e² as compared to the maximum intensity of the light spot 172, to a point on the other side of the maximum having the same intensity. Other options of quantifying the beam cross-section are feasible.

As mentioned above, FIG. 3C shows the photo current of a detector 110 according to the present invention which shows the FiP effect which is in contrast to traditional optical sensors, such as silicon photo detectors, wherein the photo current or photo signal is independent from the beam cross-section A. Thus, by evaluating the photo currents and/or other types of longitudinal sensor signals of the selected longitudinal optical sensor 132 and secondary longitudinal optical sensors 142, 142′ of the detector 110, the light beam 136 may be characterized. Since the optical characteristics of the light beam 136 depend on the distance of the object 112 from the detector 110, by evaluating these longitudinal sensor signals, a position of the object 112 along the optical axis 116, i.e. a z-position, may be determined. For this purpose, the photo currents of the selected longitudinal optical sensor 132 and secondary longitudinal optical sensors 142, 142′ may be transformed, such as by using one or more known relationships between the photo current I and the position of the object 112, into at least one item of information on a longitudinal position of the object 112, i.e. a z-position. Thus, as an example, a widening and/or narrowing of the light beam 136 may be evaluated by comparing the sensor signals of the selected longitudinal optical sensor 132 and secondary longitudinal optical sensors 142, 142′. For this purpose, known beam properties may be assumed, such as a beam propagation of the light beam 136 according to Gaussian laws, using one or more Gaussian beam parameters.

Further, the use of one longitudinal optical sensor 132 and two secondary longitudinal optical sensors 142, 142′ may provide additional advantages as opposed to the use of the longitudinal optical sensor 132 only. Thus, as outlined above, the overall power of the light beam 136 generally might be unknown. By normalizing the longitudinal sensor signals, such as to a maximum value, the longitudinal sensor signals might be rendered independent from the overall power of the light beam 136, and a modified relationship

Iₙ=g(A)

may be used by using normalized photo currents and/or normalized longitudinal sensor signals, which is independent from the overall power of the light beam 136.

Additionally, by using one longitudinal optical sensor 132 and two secondary longitudinal optical sensors 142, 142′ in the arrangement as depicted in FIGS. 2 and 3A, an ambiguity of the longitudinal sensor signals may be resolved. Thus, as can be seen by comparing the first and the last image in FIG. 3B and/or by comparing the corresponding photo currents in FIG. 3C, longitudinal optical sensors being positioned at a specific distance before or behind the focal point 138 may lead to the same longitudinal sensor signals. A similar ambiguity might arise in case the light beam 136 weakens during propagations along the optical axis 116, which might generally be corrected empirically and/or by calculation. In order to resolve this ambiguity in the z-position, the arrangement as depicted in FIGS. 2 and 3A may be employed.

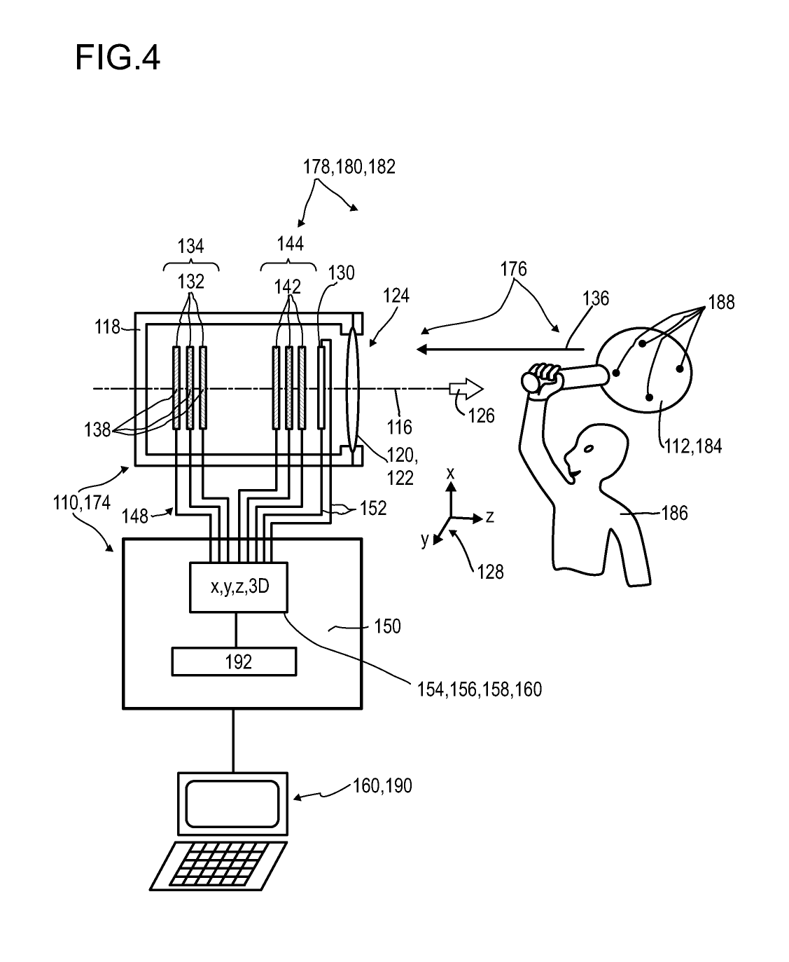

As outlined above, the optical detector 110 as, for example, shown in FIGS. 1 and 2, may be used as a camera 174, specifically for 3D imaging, and may be made for acquiring colored images and/or image sequences, such as digital video clips. FIG. 4, as an example, shows a detector system 176, comprising at least one optical detector 110, such as the optical detector 110 as disclosed in one or more of the embodiments shown in FIG. 1 or 2. Within this regard, specifically with regard to potential embodiments, reference may be made to the disclosure given above or given in further detail below. As an exemplary embodiment, a detector setup similar to the setup shown in FIG. 1 is depicted in FIG. 4. FIG. 4 further shows an exemplary embodiment of a human-machine interface 178, which comprises the at least one detector 110 and/or the at least one detector system 176, and, further, an exemplary embodiment of an entertainment device 180 comprising the human-machine interface 178. FIG. 4 further shows an embodiment of a tracking system 182 adapted for tracking a position of at least one object 112, which comprises the detector 110 and/or the detector system 176.

With regard to the optical detector 110 and the detector system 176, reference may be made to the full disclosure of this application. Basically, all potential embodiments of the detector 110 may also be embodied in the embodiment shown in FIG. 4. The evaluation device 150 may be connected to each of the at least two longitudinal optical sensors 132 and, if appropriate, to each of the at least two secondary longitudinal optical sensors 142, in particular, by the connectors 148. The evaluation device 150 may further be connected to the at least one optional transversal optical sensor 130, in particular, by the connectors 152. By way of example, the connectors 148, 152 may be provided and/or one or more interfaces, which may be wireless interfaces and/or wire-bound interfaces. Further, the connectors 148, 152 may comprise one or more drivers and/or one or more measurement devices for generating sensor signals and/or for modifying sensor signals. Further, again, the at least one transfer device 120 is provided, in particular as refractive lens 122 or convex mirror. Further, the evaluation device 150 may fully or partially be integrated into the optical sensors 130, 132, 142 and/or into other components of the optical detector 110. The optical detector 110 may further comprise the at least one housing 118 which, as an example, may encase one or more of components 130, 132 or 142. The evaluation device 150 may also be enclosed into housing 118 and/or into a separate housing.

In the exemplary embodiment shown in FIG. 4, the object 112 to be detected, as an example, may be designed as an article of sports equipment and/or may form a control element 184, the position and/or orientation of which may be manipulated by a user 186. Thus, generally, in the embodiment shown in FIG. 4 or in any other embodiment of the detector system 176, the human-machine interface 178, the entertainment device 180 or the tracking system 182, the object 112 itself may be part of the named devices and, specifically, may comprise at least one control element 184, specifically at least one control element 184 having one or more beacon devices 188, wherein a position and/or orientation of the control element 176 preferably may be manipulated by user 186. As an example, the object 112 may be or may comprise one or more of a bat, a racket, a club or any other article of sports equipment and/or fake sports equipment. Other types of objects 112 are possible. Further, the user 186 may be considered as the object 112, the position of which shall be detected. As an example, the user 186 may carry one or more of the beacon devices 188 attached directly or indirectly to his or her body.

The optical detector 110 may be adapted to determine at least one item on a longitudinal position of one or more of the beacon devices 188 and, optionally, at least one item of information regarding a transversal position thereof, and/or at least one other item of information regarding the longitudinal position of the object 112 and, optionally, at least one item of information regarding a transversal position of the object 112. Particularly, the optical detector 110 is adapted for identifying colors and/or for imaging the object 112, such as different colors of the object 114, more particularly, the color of the beacon devices 188 which might comprise different colors. An opening 124 in the housing 118, which, preferably, may be located concentrically with regard to the optical axis 116 of the detector 110, preferably defines a direction of a view 126 of the optical detector 110.

The optical detector 110 may be adapted for determining the position and/or then color of the at least one object 112. Additionally, the optical detector 110, specifically an embodiment including the camera 152, may be adapted for acquiring at least one image of the object 112, preferably a colored 3D-image. As outlined above, the determination of a position of the object 112 and/or a part thereof by using the optical detector 110 and/or the detector system 176 may be used for providing a human-machine interface 178, in order to provide at least one item of information to a machine 190. In the embodiments schematically depicted in FIG. 4, the machine 190 may be or may comprise at least one computer and/or a computer system comprising the data processing device 160. Other embodiments are feasible. The evaluation device 150 may be a computer and/or may comprise a computer and/or may fully or partially be embodied as a separate device and/or may fully or partially be integrated into the machine 190, particularly the computer. The same holds true for a track controller 192 of the tracking system 182, which may fully or partially form a part of the evaluation device 150 and/or the machine 190.

Similarly, as outlined above, the human-machine interface 178 may form part of the entertainment device 180. Thus, by means of the user 186 functioning as the object 112 and/or by means of the user 186 handling the object 112 and/or the control element 184 functioning as the object 112, the user 186 may input at least one item of information, such as at least one control command, into the machine 190, particularly the computer, thereby varying the entertainment function, such as controlling the course of a computer game.

As outlined above, the optical detector 110 may have a straight beam path or a tilted beam path, an angulated beam path, a branched beam path, a deflected or split beam path or other types of beam paths. Further, the light beam 136 may propagate along each beam path or partial beam path once or repeatedly, unidirectionally or bidirectionally. Thereby, the components listed above or the optional further components listed in further detail below may fully or partially be located in front of the at least two longitudinal optical sensors 132 and/or behind the at least two longitudinal optical sensors 132.

### LIST OF REFERENCE NUMBERS

110 detector
112 object
114 optical sensors
116 optical axis
118 housing
120 transfer device
122 refractive lens
124 opening
126 direction of view
128 coordinate system
130 transversal optical sensor
132 longitudinal optical sensor
134 longitudinal optical sensor stack
136 light beam
138 focal point
140 focal length
142, 142′ secondary longitudinal optical sensor
144, 144 secondary longitudinal optical sensor stack
146 sensor region
148 longitudinal signal leads
150 evaluation device
152 transversal signal leads
154 transversal evaluation unit
156 longitudinal evaluation unit
158 position information
160 data processing device
162 transformation unit
164 illumination source
166 primary light beam
168 imaging device
170 imaging device signal leads
172 light spot
174 camera
176 detector system
178 human-machine interface
180 entertainment device
182 tracking system
184 control element
186 user
188 beacon device
190 machine
192 track controller

1. A detector for an optical detection of at least one object, comprising:
at least one transfer device, wherein the transfer device exhibits at least two different focal lengths in response to at least one incident light beam;
at least two longitudinal optical sensors, wherein each longitudinal optical sensor has at least one sensor region, wherein each longitudinal optical sensor is designed to generate at least one longitudinal sensor signal in a manner dependent on an illumination of the sensor region by the light beam, wherein the longitudinal sensor signal, given the same total power of the illumination, is dependent on a beam cross-section of the light beam in the sensor region, wherein each longitudinal optical sensor exhibits a spectral sensitivity in response to the light beam in a manner that two different longitudinal optical sensors differ with regard to their spectral sensitivity, wherein each longitudinal optical sensor is located at a focal point of the transfer device related to the spectral sensitivity of the respective longitudinal optical sensor; and
at least one evaluation device, wherein the evaluation device is designed to generate at least one item of information on a longitudinal position, at least one item of information on a color of the object, or both, by evaluating the longitudinal sensor signal of each longitudinal optical sensor.

2. The detector according to claim 1, wherein the different focal lengths of the transfer device and the different spectral sensitivities of the at least two longitudinal optical sensors differ with respect to a wavelength of the at least one incident light beam.

3. The detector according to claim 2, wherein the different focal lengths in the transfer device are created by a chromatic aberration caused by a material in the transfer device.

4. The detector according to claim 3, wherein the transfer device comprises a refractive lens, a convex mirror, or both.

5. The detector according to claim 1, wherein the different focal lengths in the transfer device are created by different areas within the transfer device, wherein each area comprises a focal length in a manner that two different areas differ with regard to their focal length.

6. The detector according to claim 5, wherein the transfer device comprises a multifocal lens.

7. The detector according to claim 5, wherein the transfer device further comprises transition regions between adjoining areas, wherein in each transition region the focal length varies between the focal lengths of the adjoining areas.

8. The detector according to claim 7, wherein the transfer device comprises a progressive lens.

9. The detector according to claim 1, wherein the longitudinal optical sensors are arranged as at least one stack.

10. The detector according to claim 1, wherein each longitudinal optical sensor comprises at least one first electrode, at least one n-semiconducting metal oxide, at least one dye, at least one p-semiconducting organic material, and at least one second electrode.

11. The detector according to claim 10, wherein the longitudinal optical sensors differ by at least two different dyes.

12. The detector according to claim 1, wherein the evaluation device is designed to generate the at least one item of information on the longitudinal position of the object from at least one predefined relationship between the geometry of the illumination and a relative positioning of the object with respect to the detector.

13. The detector according to claim 12, wherein the evaluation device is adapted to generate the at least one item of information on the longitudinal position of the object by determining a diameter of the light beam from the longitudinal sensor signals.

14. The detector according to claim 13, wherein the evaluation device is adapted to compare the diameter of the light beam with known beam properties of the light beam in order to determine the at least one item of information on the longitudinal position of the object.

15. The detector according to claim 1, wherein the longitudinal optical sensors are arranged such that a light beam from the object illuminates all longitudinal optical sensors, wherein the evaluation device is adapted to normalize the longitudinal sensor signals and to generate the information on the longitudinal position of the object independent from an intensity of the light beam.

16. The detector according to claim 1, wherein each longitudinal optical sensor is furthermore designed in a manner that each longitudinal sensor signal, given the same total power of the illumination, is dependent on a modulation frequency of a modulation of the illumination.

17. The detector according to claim 1, wherein the evaluation device is adapted to determine the at least one item of information on the color of the object by comparing the longitudinal sensor signals of the at least two longitudinal optical sensors.

18. The detector according to claim 17, wherein the evaluation device is adapted to generate at least two color coordinates, wherein each color coordinate is determined by dividing the longitudinal sensor signal of one of the at least two longitudinal optical sensors by a normalization value.

19. The detector according to claim 1, further comprising:
at least two secondary longitudinal optical sensors, wherein each secondary longitudinal optical sensor has at least one sensor region, wherein each secondary longitudinal optical sensor is designed to generate at least one longitudinal sensor signal in a manner dependent on an illumination of the sensor region by the light beam, wherein the longitudinal sensor signal, given the same total power of the illumination, is dependent on a beam cross-section of the light beam in the sensor region, wherein each secondary longitudinal optical sensor exhibits a spectral sensitivity in response to the light beam in a manner that two secondary longitudinal optical sensors differ with regard to their spectral sensitivity,
wherein the evaluation device is further designed to generate at least one item of information on a longitudinal position of the object by evaluating the longitudinal sensor signal of each secondary longitudinal optical sensor.

20. The detector according to claim 19, wherein each secondary longitudinal optical sensor comprises the same spectral sensitivity as one of the longitudinal optical sensors.

21. The detector according to claim 19, wherein the secondary longitudinal optical sensors which comprise a different spectral sensitivity are arranged as at least one secondary stack.

22. The detector according to claim 21, wherein the stack of longitudinal optical sensors is framed by two separate secondary stacks along the optical axis of the detector.

23. The detector according claim 19, wherein the evaluation device is adapted to compare the longitudinal sensor signal of at least one of the longitudinal optical sensors with the longitudinal sensor signal of at least one of the secondary longitudinal optical sensors in order to determine the at least one item of information on the longitudinal position of the object.

24. The detector according to claim 23, wherein the evaluation device is adapted to compare the longitudinal sensor signal of a selected longitudinal optical sensor with the longitudinal sensor signal of the at least one secondary longitudinal optical sensor which comprises the same spectral sensitivity as the selected longitudinal optical sensor.

25. The detector according to claim 1, further comprising:
at least one transversal optical sensor, the transversal optical sensor being adapted to determine a transversal position of the light beam traveling from the object to the detector, the transversal position being a position in at least one dimension perpendicular an optical axis of the detector, the transversal optical sensor being adapted to generate at least one transversal sensor signal,
wherein the evaluation device is further designed to generate at least one item of information on a transversal position of the object by evaluating the transversal sensor signal.

26. The detector according to claim 25, wherein the transversal optical sensor is a photo detector having at least one first electrode, at least one second electrode and at least one photovoltaic material embedded in between the first electrode and the second electrode, wherein at least one electrode preferably is a split electrode having at least two partial electrodes, wherein the transversal optical sensor has a sensor region, wherein the at least one transversal sensor signal indicates a position of the light beam in the sensor region.

27. The detector according to claim 26, wherein electrical currents through the partial electrodes are dependent on a position of the light beam in the sensor region, wherein the transversal optical sensor is adapted to generate the transversal sensor signal in accordance with the electrical currents through the partial electrodes.

28. The detector according to claim 27, wherein the detector is adapted to derive the information on the transversal position of the object from at least one ratio of the currents through the partial electrodes.

29. The detector according to claim 1, furthermore comprising at least one illumination source.

30. The detector according to claim 29, wherein the illumination source exhibits a spectral range which is related to the spectral sensitivities of the at least two longitudinal sensors.

31. The detector according to claim 30, wherein the spectral sensitivities of the at least two longitudinal sensors are covered by the spectral range of the illumination source.

32. The detector according to claim 1, wherein the detector further comprises at least one imaging device.

33. The detector according to claim 32, wherein the imaging device comprises a camera, in particular at least one of: an inorganic camera; a monochrome camera; a multichrome camera; a full-color camera; a pixelated inorganic chip; a pixelated organic camera; a CCD chip, preferably a multi-color CCD chip or a full-color CCD chip; a CMOS chip; an IR camera; an RGB camera.

34. A human-machine interface for exchanging at least one item of information between a user and a machine, wherein the human-machine interface comprises at least one detector according to claim 1, wherein the human-machine interface is designed to generate at least one item of geometrical information and color information of the user by means of the detector wherein the human-machine interface is designed to assign to the geometrical information and color information at least one item of information.

35. An entertainment device for carrying out at least one entertainment function, wherein the entertainment device comprises at least one human-machine interface according to claim 34, wherein the entertainment device is designed to enable at least one item of information to be input by a player by means of the human-machine interface, wherein the entertainment device is designed to vary the entertainment function in accordance with the information.

36. A tracking system for tracking the position of at least one movable object, the tracking system comprising at least one detector according to claim 1, the tracking system further comprising at least one track controller, wherein the track controller is adapted to track a series of positions of the object, each position comprising at least one item of information on at least a longitudinal position of the object at a specific point in time and at least one item of information on a color of the object at a specific point in time.

37. A camera for imaging at least one object, the camera comprising at least one detector according to claim 1.

38. A method for an optical detection of at least one object,
wherein at least one transfer device of a detector is used, wherein the transfer device comprises at least two different focal lengths in response to at least one incident light beam;
wherein at least two longitudinal optical sensors of the detector are used, wherein each longitudinal optical sensor has at least one sensor region, wherein each longitudinal optical sensor generates at least one longitudinal sensor signal in a manner dependent on an illumination of the sensor region by the light beam, wherein the longitudinal sensor signal, given the same total power of the illumination, is dependent on a beam cross-section of the light beam in the sensor region, wherein each longitudinal optical sensor exhibits a spectral sensitivity in response to light beam in a manner that two different longitudinal optical sensors differ with regard to their spectral sensitivity;
wherein each longitudinal optical sensor is located at a focal point of the transfer device related to the spectral sensitivity of the respective longitudinal optical sensor;
wherein at least one evaluation device is used, wherein the evaluation device generates at least one item of information on a longitudinal position, at least one item of information on a color of the object, or both, by evaluating the longitudinal sensor signal of each longitudinal optical sensor.

39. A method, comprising optically detecting an object with the optical detector of claim 1, in order to determine a position of the object.

40. The method of claim 39, wherein the determining of the position of the object is directed to an application selected from the group consisting of a distance measurement, a position measurement, an entertainment application, a security application, a human-machine interface application, a tracking application, a photography application, an imaging application, a camera application, and a mapping application for generating maps of at least one space.
